(19) United States
(12) Patent Application Publication
(10) Pub. No.: US 2006/0200316 A1
(43) Pub. Date: Sep. 7, 2006

(54) Data correction, normalization and validation for quantitative high-throughput metabolomic profiling

(76) Inventors: Harin Kanani, Greenbelt, MD (US); Maria I. Klapa, North Bethesda, MD (US)

Correspondence Address: KRAMER & AMADO, P.C., 1725 DUKE STREET, SUITE 240, ALEXANDRIA, VA, 22314, US

(21) Appl. No.: 11/362,717

(22) Filed: Feb. 28, 2006

Related U.S. Application Data
(60) Provisional application No. 60/657,605, filed on Mar. 1, 2005.
(60) Provisional application No. 60/698,051, filed on Jul. 11, 2005.

(51) Int. Cl. G06F 19/00

(52) U.S. Cl. 702/19; 702/22

(57) ABSTRACT

Metabolomic profiling of a biological sample using a separation-molecular ID process, such as gas chromatography-mass spectrometry (“GC-MS”), requires the derivatization of the original sample. Quantitative GC-MS metabolomics is possible if the derivative is in one-to-one proportional relationship with the original concentration profile, wherein the proportionality remaining constant among samples. Two types of biases may be introduced into determination of a metabolomic profile to alter these conditions. The first type of bias is produced by a change in the proportionality size between profiles and is corrected by way of an internal standard. The second type of bias may distort the one-to-one relationship and change the proportionality between the profiles to a different fold-extent for each metabolite in a sample. The metabolomic profile data is corrected from these biases to reduce the risk of assigning biological significance to changes due only to chemical kinetics. A data correction and validation strategy provides for a weighted average of metabolite derivatives after derivatization of an original metabolite and before steady state equilibrium is established between plural metabolite derivatives to maintain high-throughput data acquisition and metabolomics analysis.

### CROSS-REFERENCE TO RELATED APPLICATIONS

This application claims the benefit of U.S. Provisional Application No. 60/657,605, filed Mar. 1, 2005, and also claims the benefit of U.S. Provisional Application No. 60/698,051, filed Jul. 11, 2005, the contents of which are incorporated herein by reference.

### STATEMENT REGARDING FEDERALLY SPONSORED RESEARCH

The work described herein was carried out, at least in part, using finds from the National Science Foundation (“NSF”) Contract No. MCB-0331312. The government may, therefore, have certain rights in the invention.

### FIELD OF THE INVENTION

The present invention relates to profiling using a derivatization-separation-molecular ID and quantification process. More particularly, the present invention relates to systematic data correction, normalization and validation for quantitative high-throughput metabolic profiling.

### BACKGROUND OF THE INVENTION

During the last decade, advances in the robotics, analytical and computational arenas, along with better understanding of the biological processes, allowed for the development of high-throughput (“omics”) techniques that revolutionized the way in which problems are now approached in life sciences. These “omics” techniques have enabled researchers to acquire a comprehensive picture of cellular fingerprints at the molecular level. In the conventional low-throughput biological analysis, due primarily to technological and computational limitations, the response of the system to a particular perturbation was monitored through macroscopic observations and usually few measurements at the molecular level. In this context, conventional biological analysis had to heavily rely on the accuracy of an initial hypothesis based on which a few attainable molecular measurements had to be selected. Therefore, any conclusions or models derived from such analysis depended upon the sensitivity of the markers of the examined process, i.e. the acquired measurements. Moreover, only the initial hypothesis could be validated, while any simultaneously occurring biological processes that were not “mapped” in the acquired measurements risked being missed. The advantages, thereby, of high-throughput “omic” analyses become clear. They do not require initial hypotheses, while now parallel occurring phenomena could be correlated, thereby enabling the development of more extensive, detailed and accurate models. Hence, high-throughput analyses can significantly upgrade the information extracted about a biological system and/or problem.

Most of the attention during the last decade has been paid to the transcriptional profiling analysis using cDNA microarrays or the Affymetrix Genechip®. The use of transcriptional profiling enables the monitoring of the expression of every single gene in the entire genome. However, high gene expression does not directly translate into high protein concentration (due to posttranslational modifications), neither high protein concentration leads de facto to high in vivo enzymatic activity and metabolic reaction rate due to regulatory mechanisms active at the metabolic level. In this context, it is becoming increasingly clear that comprehensive analysis of the complex biological systems requires the quantitative integration of all cellular fingerprints: genome sequence, maps of gene and protein expression, metabolic output, and in vivo enzymatic activity. In a systematically perturbed cellular system, such integration can provide insight about the function of unknown genes, metabolic regulation and even the reconstruction of the gene regulation network.

To achieve this objective of integrative analyses, during the last decade numerous “omics” techniques, technologies, and methodologies assessing different levels of cellular function have been developed for analyzing substances; e.g. proteomics for the measurement of protein concentration level, lipidomics for the high-throughput measurement of the lipid concentration, fluxomics for the high-throughput measurement of metabolic fluxes from isotope incorporation in metabolites, and metabolomics for the high-throughput measurement of metabolic state of a cellular system, to state a few. To date, these techniques, technologies, and methodologies have yet to be fully standardized.

Consequently, there is a need for a quantitative high-throughput analysis of the above “omics” techniques, technologies, and methodologies. More specifically, there is a further need for a systematic methodology including experimental and algorithmic components that address and resolve current limitations in quantitative metabolomic analysis using a derivatization-separation-molecular ID and quantification analytical technique.

### SUMMARY OF THE INVENTION

The metabolomic profile of a biological system—referring to the concentration profile of all its free metabolite pools—provides a phenotypic correspondent of the high-throughput transcriptional and proteomic profiles. The metabolomic profile is typically measured through a separation-molecular ID and quantification process. Gas Chromatography-Mass Spectrometry (“GC-MS”) has emerged as a popular and advantageous separation-molecular ID and quantification process for metabolomic profiling. However, GC-MS metabolomics belongs to the separation-molecular ID and quantification processes, which require the derivatization of the original sample. To be detected through GC-MS, the metabolites have to first be converted to a volatile, non-polar and thermally stable derivative form. The present invention concerns, in general, the use of derivatization-separation-molecular ID and quantification processes in metabolomic profiling. In particular, the present invention deals with GC-MS as the most representative and commonly used technique in metabolomic profiling research. For the sake of space and simplicity, in the rest of the text any issues arising in the context of metabolomics using any derivatization-separation-molecular ID and quantification process, which concern the present invention, will be discussed in the context of GC-MS metabolomics.

To obtain a metabolomic profile, an extraction of the metabolite derivatives' mixture is first performed. In this case, quantitative metabolomic analysis is possible when the concentration of each metabolite in the extracted mixture is in one-to-one directly proportional relationship with the peak area of the metabolite derivative's marker ion (or the sum of the peak areas of the metabolite derivative's marker ions) and the proportionality constant remains the same among all compared samples. However, biases are introduced at each of the four steps of the GC-MS metabolomic data acquisition process, i.e. extraction, derivatization, profile acquisition, and peak identification and quantification. These biases may affect the proportionality between the composition of the extracted metabolite mixture and its metabolomic profile, thereby hindering the comparison among data from different experiments/batches. In this case, appropriate data correction, normalization and validation is performed to produce accurate and comparable datasets before conducting any further analysis to identify biologically relevant patterns.

The potential systematic biases in GC-MS metabolomics can be divided into two categories, depending on whether they affect all metabolites to the same extent or not. The first type of biases are common among all analytical techniques used in metabolomics, however, the second type of biases are specific to metabolomic analysis using GC-MS or any other derivatization-separation-molecular ID and quantification process. In the first category, the errors change the proportionality ratio between a metabolite's original concentration and the peak area of its derivative's marker ion to the same fold-extent for all metabolites. Therefore, in the presence of only this type of bias, the relative composition of the measured derivative profile should be the same as that of the original sample, assuming one-to-one directly proportional relationship between the original and the derivative concentration profiles. To enable quantitative comparison between spectra, these biases can be accounted for through the use of an internal standard.

The second type of biases in GC-MS metabolomics distorts the one-to-one relationship between the extracted and the derivative metabolite mixtures and might affect the proportionality ratio between a metabolite's concentration in the extracted mixture and the peak area of its derivative's marker ion to a different fold-extent for the various metabolites in the mixture. The reasons behind this second type of biases are twofold: (a) some metabolites form more than one derivative, despite efforts to ensure a single derivative per metabolite; and (b) the derivative profile depends on the composition of the original sample and the duration of the derivatization. This second type of biases will hinder the comparison of the relative concentrations of the metabolites within the same sample, but also the comparison of the relative concentration of a metabolite among different samples, if not appropriately normalized for. In addition, differences in the quantified profile of different samples that are potentially due only to chemical kinetics and/or the experimental and analytical setup could be attributed biological significance, thus leading to erroneous conclusions.

While the second type of errors in the GC-MS spectra of certain classes of molecules have been known since the late 1960s, in the metabolomics community the discussion about these biases has been quite limited. In this context, no streamlined data correction strategy has ever been suggested for high-throughput GC-MS metabolomic profiling analysis. Experimental solutions of the problem include the use of a certain derivatization process that produces only one derivative per metabolite. However, such solutions are not high-throughput and are applicable only for the specific derivatization.

An embodiment of the present invention provides a data correction, normalization and validation strategy that does not jeopardize the high-throughput nature of the metabolomic profiling using GC-MS or any other derivatization-separation-molecular ID and quantification process.

Further areas of applicability of the present invention will become apparent from the detailed description provided hereinafter. It should be understood that the detailed description and specific examples, while indicating the preferred embodiments and best mode of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a schematic illustration of a separation-molecular ID system including a gas chromatograph and a detector;

FIG. 2 is a schematic illustration of the detector of FIG. 1 in the form of a mass spectrometer and mass spectrum analyzer;

FIG. 3 is a graph illustrating an output scan of mass spectrum from a GC-MS process of the trimethyl-silyl derivative (“TMS”) of ribitol at a certain retention time;

FIG. 4 is a graph of mass spectra of the compounds eluted from the GC at retention times around the time of the mass spectrum of FIG. 3;

FIG. 5 is a graph of a Total Ion Current (“TIC”) plot, which is a projection of the 3-D plot shown in FIG. 3B on the retention time and ion current intensity (“IC”) plane;

FIG. 6 is a graph of an integration of the TIC plot in FIG. 5 to estimate the peak area that corresponds to the particular compound;

FIG. 7 is a table of a comparison of GC-MS, LC-MS and NMR in metabolomics analysis;

FIG. 8 is a flow chart of operations for metabolomic analysis according to a preferred embodiment of the present invention;

FIG. 9 illustrates a graph, including sub graphs, showing variations in concentrations for an original metabolite and three categories of metabolite derivatives as a function of time;

FIG. 10 illustrates a flow chart of a filtering/correction strategy for high-throughput metabolomic profiling according to a preferred embodiment of the present invention;

FIG. 11 illustrates a flow chart corresponding to operation 1008 set forth in FIG. 10;

FIG. 12 illustrates a table of all consistently observed TMS-derivatives of 26 metabolites containing an amine group in a mass spectrum of a plant sample or metabolite standard runs;

FIG. 13 illustrates a table of estimated wᵢ^{M} values of all metabolites shown in table 1200 of FIG. 12;

FIG. 14 illustrates a table showing observed retention times of all metabolites shown in table 1200 of FIG. 12;

FIGS. 15A-15E illustrate tables showing relative peak areas which were used for estimating wᵢ^{M} values for metabolites in table 1300 of FIG. 13;

FIG. 16 illustrates a table showing observed relative cumulative peak areas of metabolites containing an amine group in plant sample 1 and plant sample 2; and

FIG. 17 illustrates a table showing a composition of metabolite mix standard.

### DETAILED DESCRIPTION OF THE PREFERRED EMBODIMENTS

Metabolomic Analysis

The metabolomic profile of a biological sample, e.g. animal/plant tissue or cell culture, biological fluids like blood, urine, plant exudates, phloem sap, etc., refers to the concentration profile of all its free small metabolite pools. Metabolites are defined as the small molecules that participate in the metabolic reactions as substrates or products; debate still exists regarding the maximum size of the “small” metabolites, which will also determine the size of the entire metabolome. Taking into consideration that the concentrations of the metabolites affect and are affected by the rates of the metabolic reactions (or metabolic fluxes), it becomes apparent that the metabolomic profile of a biological system provides a fingerprint of its metabolic state. As such, it is a phenotypic correspondent of the transcriptomic and proteomic profiles, which provide, respectively, the cellular fingerprint at the transcriptional (mRNA) and translational (protein) levels.

To obtain the metabolomic profile of a biological system the following three steps are preferably followed:

1) Extraction of the metabolites from the biological sample;

2) Measurement of the composition of the extracted metabolite mixture using a particular analytical technique; and

3) Correction, Normalization and Validation of the acquired datasets to account for any experimental biases.

The result of these three steps is a set of hundreds of (either absolute or relative with respect to a standard) metabolite concentrations for each biological sample. The acquired datasets are to be further analysed using multivariate statistical analysis techniques to identify specific concentration patterns of biological relevance, as is the case with any high-throughput omic dataset. The accuracy of the derived conclusions regarding the system's physiology, strongly depends, however, on whether the three initial steps have been correctly applied. Any biases introduced at the first two stages, for which the data have not been correctly normalized at the third stage could significantly affect the results of the statistical analysis. The present invention refers mainly to stages (2) and (3). For better understanding the objective and the concept of the invention, all three stages (1-3) of metabolomic analysis are described below.

Metabolite Extraction

Depending on the class of metabolites/small molecules that are targeted from a particular analysis, the extraction methods can be categorized in three types, namely: Extraction of free metabolite pools, Vapor Phase Extraction, and Total Metabolite Extraction. The first type of extraction, Extraction of free metabolite pools, is mainly used in metabolomics research. In this case free intracellular metabolite pools are obtained from a biological sample through methanol-water extraction for polar metabolites, or chloroform extraction for non-polar metabolites. The second type of extraction, Vapor Phase Extraction, refers to the extraction of metabolites that are volatile at room temperature. The metabolites are expelled from the biological sample in the vapor phase. These metabolites are either measured directly by connecting the flask or reactor in which the vapors are generated to the analytical instrument, or by absorbing first the vapors in charcoal/solvent and then analyzing the acquired solution. The third type of extraction, Total Metabolite Extraction, refers to the extraction of the free metabolite pools along with the metabolites that have been incorporated in cellular macromolecules, e.g. lipids, proteins etc. The present invention provides extraction of a particular class of metabolites from macromolecules (e.g. amino acids from proteins or sugars from cell wall components). The present invention also provides a combined high-throughput method which extracts all metabolites simultaneously.

Measuring Metabolite Concentrations

The measurement of the metabolite concentrations in the extracted metabolite mixture is carried out by a separation-molecular ID and quantification process. Examples include Gas or Liquid Chromatography-Mass Spectrometry (“GC/LC-MS”), Nuclear Magnetic Resonance spectroscopy (“NMR”) or more recently by Capillary Electrophoresis-Mass Spectrometry (“CE-MS”). The present invention relates to techniques used in the determination of the concentration of small molecules in a biological sample in a high-throughput way along with the present experimental design for metabolomic profiling analysis. The present invention deals primarily with the application of Gas Chromatography-Mass Spectrometry and under specific circumstances to be discussed later in the text with Liquid Chromatography-Mass Spectrometry. Therefore, these analytical techniques will be analyzed in greater detail in the next paragraphs.

Chromatography, in general, is a method for mixture component separation that relies on differences in the flowing behavior of the various components of a mixture/solution carried by a mobile phase through a support/column coated with a certain stationary phase. Specifically, some components partition strongly to the stationary phase and spend longer time in the support, while other components stay predominantly in the mobile phase and pass faster through the support. The criterion based on which the various compounds are separated through the column is defined by the particular problem being investigated and imposed by the structure, composition and surface chemistry of the stationary phase. For example, a stationary phase could be constructed such that the linear and low molecular weight molecules elute faster than the aromatic and high-molecular weight ones. As the components elute from the support, they can be immediately analyzed by a detector or collected for further analysis. A vast number of separation methods, and in particular chromatography methods, are currently available, including Gas Chromatography (“GC”), Liquid Chromatography (“LC”), Ion Chromatography (“IC”), Size-Exclusion chromatography (“SEC”), Supercritical-Fluid Chromatography (“SFC”), Thin-Layer Chromatography (“TLC”), and Capillary Electrophoresis (“CE”). Gas Chromatography, the main chromatographic technique to be discussed along with the present invention, can be used to separate volatile compounds. Liquid chromatography (“LC”) is an alternative chromatographic technique useful for separating ions or molecules that are dissolved in a solvent. The principle of GC and LC separation is the same, their main difference lies on the phase in which the separation occurs (vapor vs. liquid phase). In addition, GC is used primarily to separate molecules up to 650 atomic units heavy, while, in principle, a LC can separate any molecular weight compounds, this being the reason for which it is used mainly in proteomic analysis.

As stated above, a separation method, such as chromatography, could be combined with a molecular ID and quantification technique. A molecular ID technique is also known as an analytical technique and is used for the identification and quantification of the eluted components. The combined procedures are known as “hyphenated techniques.” Examples of separation-molecular ID and quantification techniques include gas chromatography-mass spectrometry (“GC-MS”), liquid chromatography-mass spectrometry (“LC-MS”), gas chromatography-Fourier-transform infrared spectroscopy (“GC-FTIR”), High Performance Liquid Chromatography-Ultraviolet and Visible absorption spectroscopy (“HPLC-UV-Vis”), and capillary electrophoresis-mass spectrometry. The field of metabolomics may also use separation-molecular quantification techniques. Examples of separation-molecular quantification techniques include gas chromatography-flame ionization detection (“GC-FID”), and gas chromatography-electron capture detection (“GC-ECD”). A technique is a separation-molecular ID technique if the identification of the molecule is provided by the technique. A technique is a separation-molecular quantification technique if a quantity corresponding to the molecule to be identified is known from the technique. For separation-molecular quantification, the retention time of the detected molecule is compared to a known retention time, such as by a chromatography process, for molecular identification.

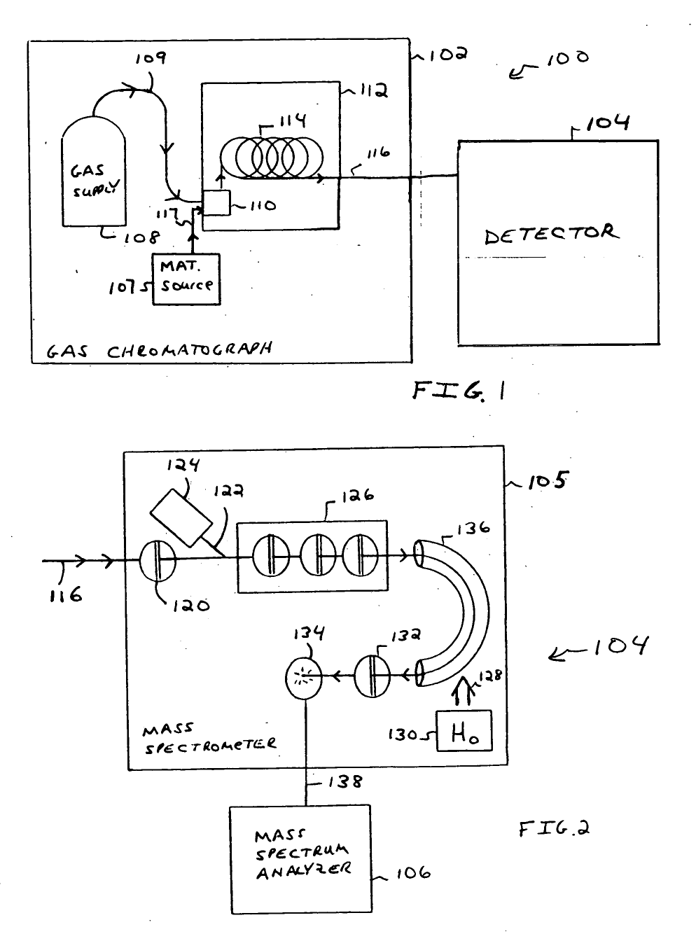

FIG. 1 is a schematic illustration of a separation-molecular ID and quantification system 100. According to the illustrated embodiment, the separation component is in the form of gas chromatograph 102 and the molecular ID and quantification component is in the form of detector 104. The flow of the compounds is denoted by arrows. The gas chromatograph 102 includes a gas supply 108, which provides a flowing mobile phase 109. The flowing mobile phase is received by injector port 110 of oven unit 112. The material for analysis is provided by material source 109 and is injected into port 110 along with the gas. After entry into the injector port 110, the flowing material enters support 114, also known simply as a “column,” for interaction with the stationary phase. The organic compounds are then separated due to differences in their partitioning behavior between the mobile gas and the stationary phase. This separation occurs in column 114. The separated compounds are then eluted at different times from column 114 and exit gas chromatograph 102 for detection and/or analysis by detector 104.

The flowing material through the column is usually propagated by inert gases such as helium, argon, or nitrogen. The injection port 110 is typically a rubber septum through which a syringe needle is inserted to inject the material sample. The injection port 110 is maintained at a higher temperature than the boiling point of the least volatile component in the sample mixture. Because the partitioning behavior between the mobile and the stationary phase of the various sample components depends on the temperature, the separation column is usually maintained in a thermostat-controlled oven 112. Separating components with a wide range of boiling points is accomplished by starting at a low oven temperature and increasing the temperature over time to elute the high-boiling point components.

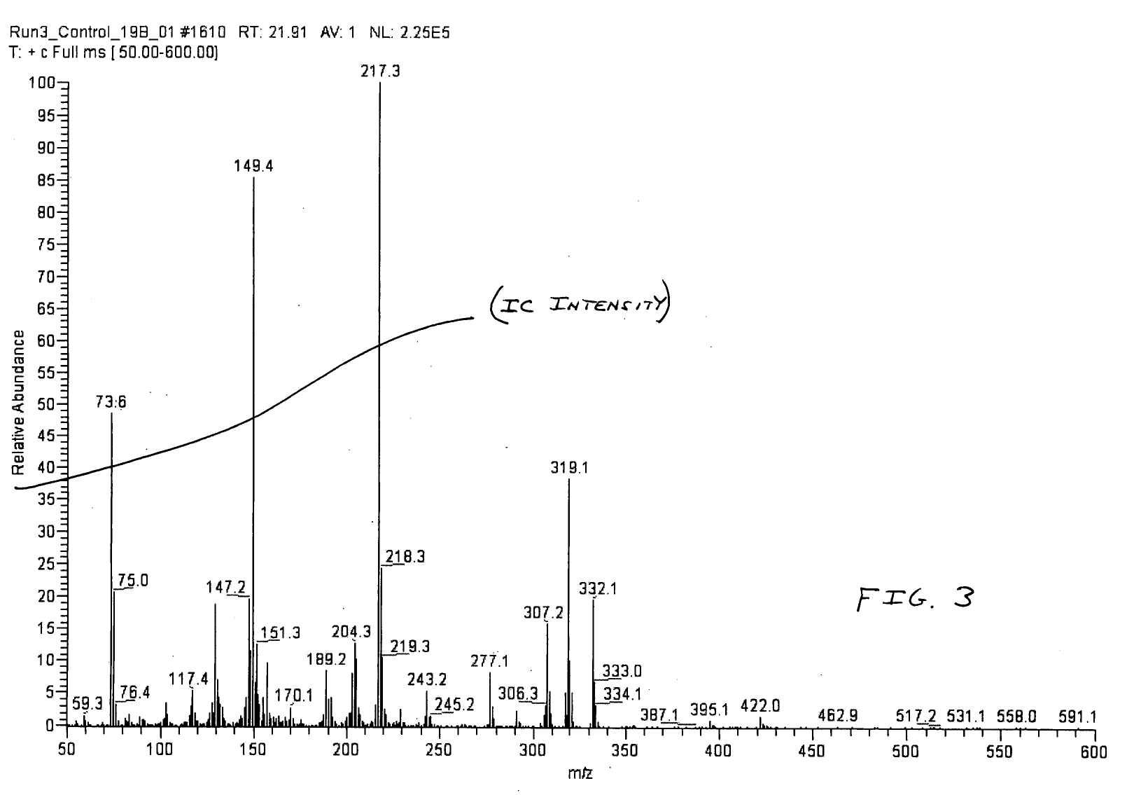

FIG. 2 is a detailed schematic illustration of detector 104 including mass spectrometer 105 and mass spectrum analyzer 106. Mass spectrometer 105 receives separated flowing material 117 from the gas chromatograph 102. The material is usually in the form of flowing molecules in a vacuum, and a small portion of the material enters by way of entry slit 120. The molecules separated from the chromatograph are not in ionized form. These molecules cannot be detected from the mass spectrometer unless ionization occurs. Two types of ionization are available: electron or chemical ionization. In the electron ionization (“EI”), the material entering the MS is bombarded by electron beam 122 from electron source 124. The electron beam typically has sufficient energy to fragment the molecules in material 117. In the case of chemical ionization (“CI”), the molecules of an “intermediate” gas (usually methane) are bombarded by the electron beam and ionized. Then, the ions of the “intermediate” gas collide with the material entering MS from the chromatograph. Because these collisions do not generate sufficient energy to fragment the molecules in material 117, usually it is mainly the molecular ion of these molecules that is produced. Therefore, CI is primarily used for compound identification and determination of its molecular weight. The positive fragments which are produced after the ionization step, i.e. cations and radical cations, are then accelerated by accelerating array 126, and sorted based on their mass-to-charge ratio by a magnetic field 128. The magnetic field is produced by field generator 130. The sorted molecules then pass through exit unit 132, and are detected by collector plate 134. Because the bulk of the ions produced in the mass spectrometer carry a unit of positive charge, their mass-to-charge ratio “m/z” is equivalent to the molecular weight of the corresponding molecular fragment.

Both GC- and LC-MS and all the other “hyphenated” techniques mentioned above are used for separation-molecular ID and quantification. The samples to be analyzed by any of these techniques have to be in such initial form that their separation through the associated chromatograph is possible. For example, GC-MS can only be used to identify and quantify volatile compounds. If the compounds to be measured are not volatile in their natural form, they need to be converted to volatile derivatives through a chemical reaction/derivatization process prior to the separation-molecular ID and quantification. Depending upon the requirements of the chromatographic separation, the derivatization step could be used to enhance/modify apart from volatility, e.g. thermal stability, polarity, optical activity or magnetic properties. In this case, the samples are said to undergo a derivatization-separation-molecular ID and quantification process. Common examples of derivatization techniques used with Gas Chromatography are: Silylation, Esterification, Acylation, Protective Alkylation, Cyclization, Ketone-Base Condenstation, Oxime formation, Nitrophenyl derivatives, colored and UV-forming derivatives, etc. Depending on the type of chemical compounds or metabolites being measured, one or more of the derivatization techniques is used for transforming the original chemical compound/metabolite mixture into a form with desired properties. Whenever derivatization is used, the sample that is finally detected and quantified by the molecular ID and quantification process is the derivative and not the original sample. Derivatization adds an additional step to the experimental protocol, but more importantly adds a number of issues to be properly addressed.

When the above process is a metabolomics analysis using GC-MS, most of the targeted molecules are polar and not volatile. Therefore, before using GC-MS for the metabolomic analysis of a biological sample, the sample needs to be first derivatized to form volatile and non-polar derivatives. While derivatization adds an additional step and introduces data correction issues to GC-MS metabolomic analysis as compared to LC-MS, GC-MS is preferred. GC-MS provides a technological advantage over LC (or CE)-MS because: chromatographic separation is more efficient in the vapor phase as compared to the liquid phase. A derivatization method in GC-MS metabolomics analysis aims at the production of the trimethylsilyl (“TMS”)—oxime derivatives of the metabolites in the biological sample. This derivatization takes place in two steps. First, the ketone and aldehyde groups of the metabolites are converted to their more stable oxime derivatives using methoxy amine solution in pyridine solvent. Then, all active hydrogen atoms, e.g. in hydroxyl (—OH), carboxylic (—COOH) and amine (—NH₂) functional groups, are replaced by TMS (—Si(CH₃)₃) groups through reaction with silylating agents, e.g. N-methyl-trimethylsilyl-trifluoroacetamide (“MSTFA”), N,O-Bis(trimethylsilyl)trifluoroacetamide (“BSTFA”), Trimethylsilylchloride (“TMCS”). The BSTFA and TMCS are alternative derivatizing agents for TMS derivatives. In the case of GC-MS metabolomic analysis including the derivatization step, what is finally detected by the MS is the spectrum of the derivatives of the metabolites in the original sample and not the original sample per se. This issue is associated with the present invention as described in greater detail below in the Data Correction and Normalization section.

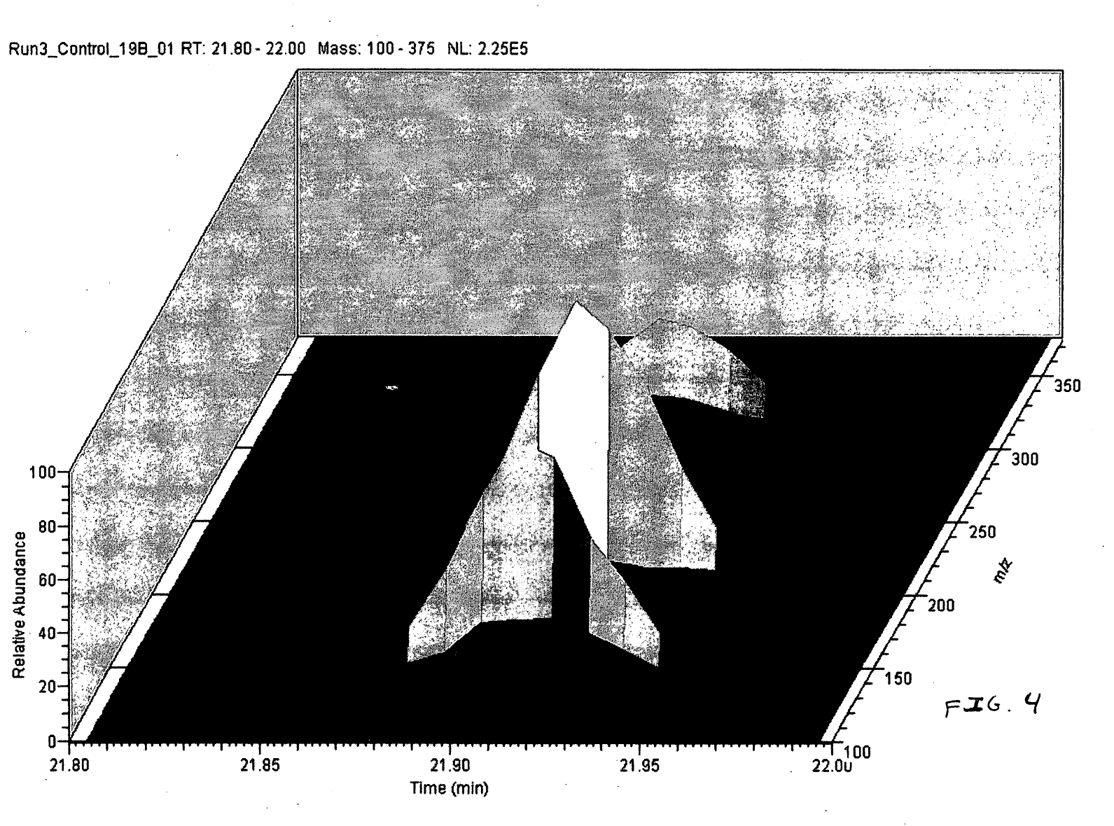

FIG. 3 is a graph illustrating an output scan of mass spectrum from a GC-MS process. Throughout a particular GC(or LC)-MS run, which duration varies depending on the particular GC(or LC) separation method used, and based on the principles of the GC(or LC)-MS data acquisition process as previously described, each scan of the equipment generates a mass spectrum. The mass spectrum scan of FIG. 3 is a plot of ion current (“IC”) intensity with respect to mass-to-charge ratio m/z and corresponds to a particular retention time. The latter is defined as the time after the injection of the original sample and, thereby, for a particular compound is equal to the time that it spent in the GC (or LC) support/column. The IC intensity is proportional to the total amount of ions of a certain mass-to-charge ratio m/z that are produced from the ionization of the compounds eluting from the GC at the particular retention time. The mass spectrum changes with time (from scan to scan), as the amount and/or type of compounds entering the mass spectrometer from the GC (or LC) changes throughout the run.

FIG. 4 is a graph illustrating a change in mass spectrum with respect to time. FIG. 4 represents the combined mass spectrum data of FIG. 3. Hence, when combined, all recorded mass spectra form a 3-D plot with x-, y- and z-axes corresponding, respectively, to retention time, m/z, and IC intensity as illustrated in FIG. 4. The projection of this 3-D plot on the y-z axes is the mass spectrum, while its projection on the x-z axis, i.e. retention time vs. IC intensity, is called the Total Ion Current (“TIC”) or Reconstructed Ion Current (“RIC”) plot.

Typically, in most GC/LC-MS applications, the mass spectrum of a compound is sufficient for its identification. However, in metabolomic analysis, many extracted metabolites are isomers and thus have the same molecular weight and slightly different structure, e.g. glucose, fructose, galactose, etc. These metabolites upon ionization are similarly fragmented; thereby it is difficult for a compound to be identified by its mass spectrum alone. Their slightly different structure—in the particular example, the position of the hydroxyl group-, however, imposes different chromatographic properties. This difference enables the separation of the isomers based on their different retention time. Thus, it is the combination of the retention time for a particular set of chromatographic conditions and the mass spectrum that is unique for most metabolites and can be used for their identification.

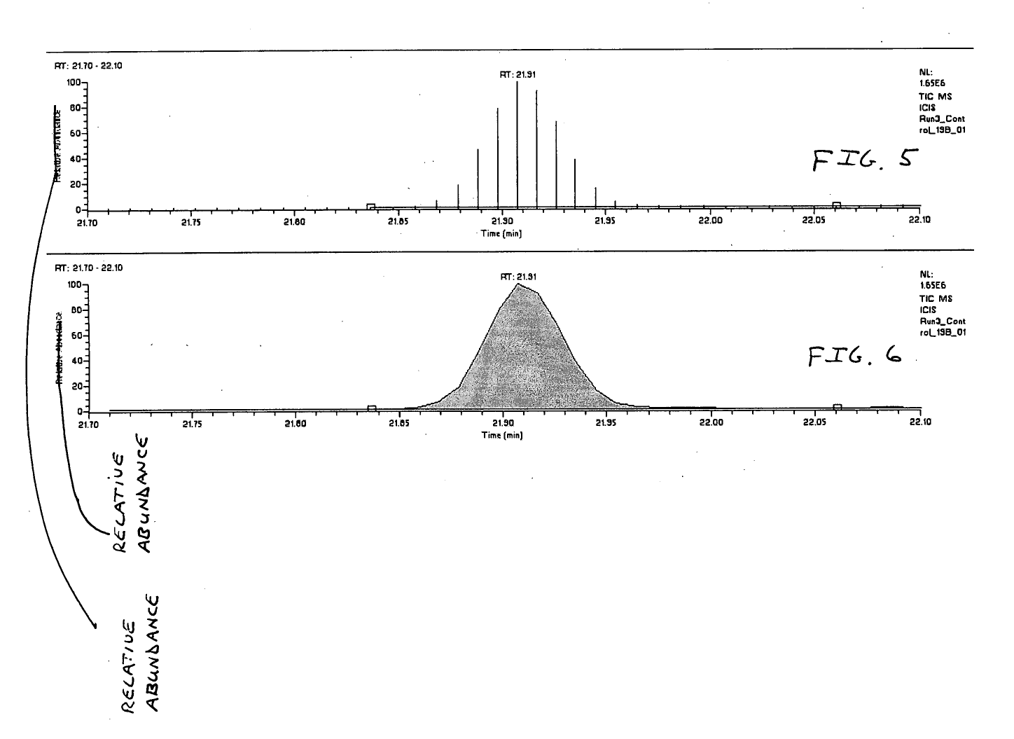

FIG. 5 is a graph of a projection of the 3-D plot shown in FIG. 3B on the retention time and ion current intensity (“IC”) plane. This is called the Total Ion Current (“TIC”) plot. The area under the TIC plot is directly proportional to number of molecules of the particular compound that were detected by the mass-spectrometer during a given scan.

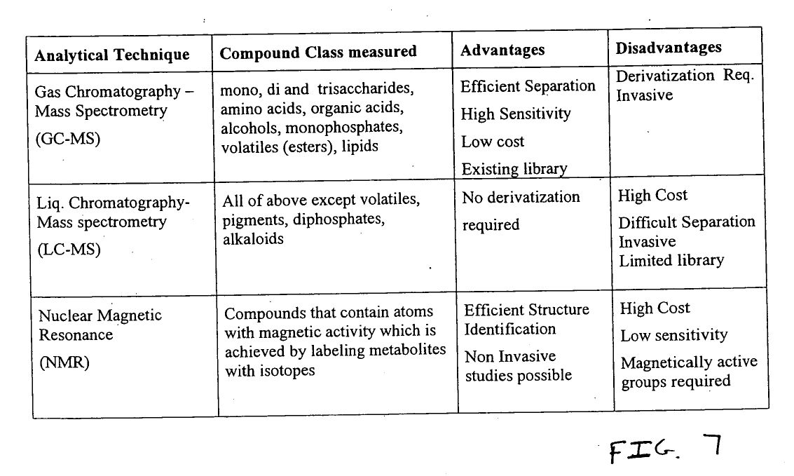

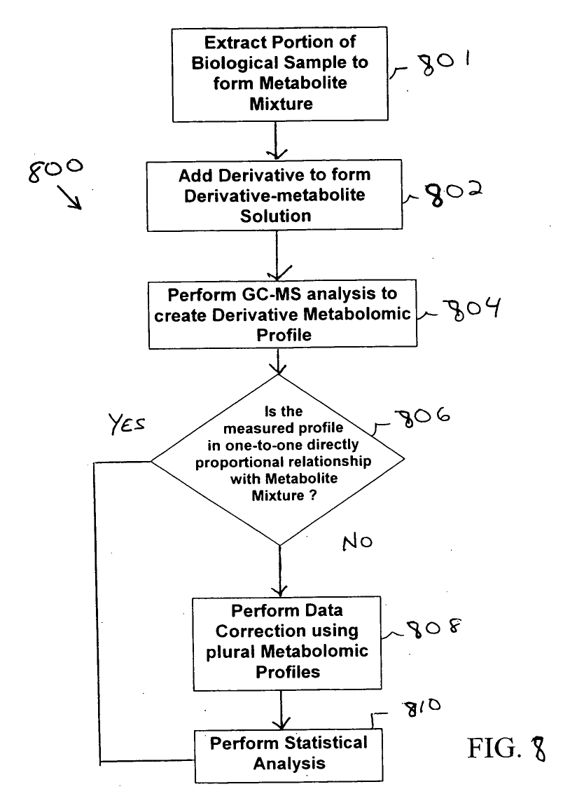

FIG. 6 is a graph of an integration of the TIC plot in FIG. 5 to estimate the peak area that corresponds to the particular compound. In particular, the TIC peak shown in FIG. 6 corresponds to a retention time of 21.912 min for the mass spectrum shown in FIG. 3. Based on the detected mass spectrum, the compound could have been identified as corresponding to the TMS-derivative of ribitol, xylitol or arabinose. However, based on the combination of retention time and mass spectrum, the combination can be identified only as TMS-ribitol. This retention time and mass spectrum combination will remain unique for ribitol and all the other compounds as long as the GC/LC-MS conditions are held constant. After the identification of a compound, it is quantified by integrating the peak area of its TIC plot.

The above quantification hold true when only one compound is eluting from the GC support/column at a particular retention time/scan. There are compounds, however, in a complex mixture that might co-elute. In this case, the TIC plot will not be as simple as shown in FIG. 6, but might consist of a peak with more than one crests or a wider peak that corresponds to more than compounds. In these cases, it is not possible to quantify the individual compounds by just using the TIC plot. Each, however, of the compounds is expected to have a characteristic fragment ion in its mass spectrum, barring the extremely complicated cases of quite similar compounds that have to be identified and quantified through other analytical techniques. If plotting, therefore, the current intensity (“IC”) with respect to the retention time of the characteristic ion for each of the co-eluting compounds, the IC plots are expected to be as clean as the TIC plot for the compounds that leave the chromatograph separately of the others as illustrated in FIG. 6.

However, based on the principles of the MS function, the peak area of the characteristic fragment ion of a particular compound is expected to be a fraction of all its fragments' ions' counts; this fraction remains constant as long as the equipment's conditions are held constant. The total ion counts of a compound are directly proportional to the compound concentration in the original sample, barring any MS equipment saturation effects. Therefore, the proportionality ratio between the peak area of the characteristic fragment ion of a particular compound and its concentration in the original sample remains the same as long as the GC/MS equipment's conditions are held constant within its linear range of operation/detection. Therefore, the IC plot of the characteristic ion of a particular compound could be used for the quantification of this compound's concentration. The characteristic fragment ion is then called this compound's quantifying or marker ion. The proportionality ratio of the peak area of the quantifying ion of a particular compound and its concentration in the original sample is also known as the “response ratio” or “response factor” for the particular compound and for the particular marker ion. Because there are many co-eluting peaks in a GC/LC-MS metabolomic profile, marker ions are used for the quantification of all metabolites, for the sake of uniformity.

Data Correction and Normalization

Metabolomics analysis with any analytical technique is based on the assumption that the concentration of each metabolite in the original sample is in one-to-one directly proportional relationship with the peak area of the metabolite's marker ion (or the sum of the peak areas of the metabolite's marker ions), as the marker ion is defined in the previous section. Even further, metabolomics using GC-MS or any other derivatization-separation-molecular ID and quantification process is based on the assumption that the concentration of each metabolite in the original sample is in one-to-one directly proportional relationship with the peak area of its derivative's marker ion. Biases introduced at each stage of the metabolomic data acquisition process, might affect this proportionality, hindering the comparison between data from different experiments/batches. The present invention concerns metabolomics using a derivatization-separation-molecular ID and quantification technique, therefore it is the type of biases to be addressed in these cases that will be discussed in greater detail in this section. The potential biases in metabolomics using a derivatization-separation-molecular ID and quantification technique (GC-MS will be used as the characteristic example of such analysis in the rest of the text) can be divided into two categories, namely errors that similarly affect all metabolites, and errors that affect specific metabolites.

Errors that Similarly Affect All Metabolites

Certain errors or “biases” affect all metabolites equally. These biases, e.g. unequal division of a sample into replicates, injection errors, variation in split ratios, etc., are expected to change the proportionality ratio between a metabolite's original concentration and the peak area of its derivative's marker ion to the same fold-extent for all metabolites. Therefore, barring any other type of biases, the relative composition of the measured derivative metabolomic profile should be the same as of the original sample.

Errors that Affect Specific Metabolites

Certain errors or biases affect specific metabolites. These biases are expected to change the proportionality ratio between a metabolite's original concentration and the peak area of its marker ion to a different fold-extent for the various metabolites in the sample. They concern primarily the relationship between the composition of an extracted metabolite mixture and that of its derivative mixture, which depends on the derivatization type and duration. Sources of such biases include: (a) the incomplete derivatization of a metabolite at the time of sample injection into the analytical equipment; and (b) the formation of multiple derivatives from one metabolite. The extent to which this type of biases affect the quantification of a particular metabolite in the original sample depends on the molecular structure, the concentration of the metabolite, but also on the composition of the original metabolite mixture, which might affect the kinetics of the derivatization process. These errors should be identified in the measured profile and be properly accounted for, because if not, they could change the relative composition of the measured derivative metabolomic profile with respect to that of the original sample. In this case, changes in the profile that are due only to chemical and/or experimental and analytical setup reasons could be attributed biological significance, leading thus to erroneous conclusions.

In view of the above, the first type of biases are common among all analytical techniques used in metabolomics, however, the second type of biases are specific to metabolomic analysis using GC-MS or any other derivatization-separation-molecular ID and quantification process. To account for these two types of biases and render the acquired data within the same experiment and/or within different experiments/batches comparable, the raw data is corrected and appropriately normalized before any further data analysis for the identification of biologically significant patterns. To account for the first type of biases, an Internal Standard Normalization is required. The selected internal standard (“IS”) should not be produced—at least not to the extent that it distorts the acquired data—by the biological system. The IS is added at a known concentration externally to the biological sample just before the metabolite extraction takes place. In this way, the IS undergoes the same analytical steps as the rest of the metabolites in the extracted mixture. Each metabolite is then quantitatively characterized by the ratio of the peak area of its marker ion(s) to the peak area of the marker ion(s) of the internal standard. The obtained peak area ratio is referred to as the “relative peak area” (“RPA”) of the metabolite. If the equipment functions within its linear range of operation and in the absence of any other type of biases, the metabolite RPAs are directly proportional to the relative (with respect to the internal standard) concentration of the original metabolites.

Ribitol or isotopes of known metabolites have been the most commonly used IS's so far in metabolomics analysis and are added to the sample just before the extraction step. Methyl ester of acids, which are not present in biological samples have also been used. In some of the experimental protocols multiple ISs belonging to different classes of metabolites have been used to account for any differences throughout the extraction, derivatization and GC-MS measurement process between different molecular classes. The description in the present invention refers to the use of only one Internal Standard for all the metabolites. However, it would still be valid even if multiple internal standards have been used.

In all high-throughput metabolomic analyses that have been reported to-date, only internal standard normalization has been used. The latter, however, does not account for the second type of biases in metabolomics using GC-MS or any other derivatization-separation-molecular ID and quantification process, limiting thus the accuracy and inhibiting the standardization of the metabolomics studies using these analytical techniques. Therefore, there exists strong need for the development of methods for the appropriate correction, normalization and validation of the GC-MS (or any other derivatization-separation-molecular ID and quantification process used in) metabolomics data from the second type of biases as the latter was previously described. It is also mandatory for these methods to be applicable in such a way that they do NOT jeopardize the high-throughput nature of the metabolomic profiling analysis. The present invention involves the development of such a data correction and normalization method for metabolomic profiling analysis using GC-MS (or any other derivatization-separation-molecular ID and quantification process).

Embodiments of the present invention provide methods for correction, normalization and validation of a high-throughput data set produced by a derivatization-separation-molecular ID and quantification process. Embodiments of the present invention also provide for high through-put metabolomic profiling analysis. Although embodiments of different methods are described with reference to gas chromatography-mass spectrometry (“GC-MS”), it is to be understood that the methods are applicable to any type of separation-molecular ID and quantification process, such as separation-spectroscopy or separation-spectrometry, yielding spectrum data with information proportional to component concentrations and which requires prior derivatization of the original sample.

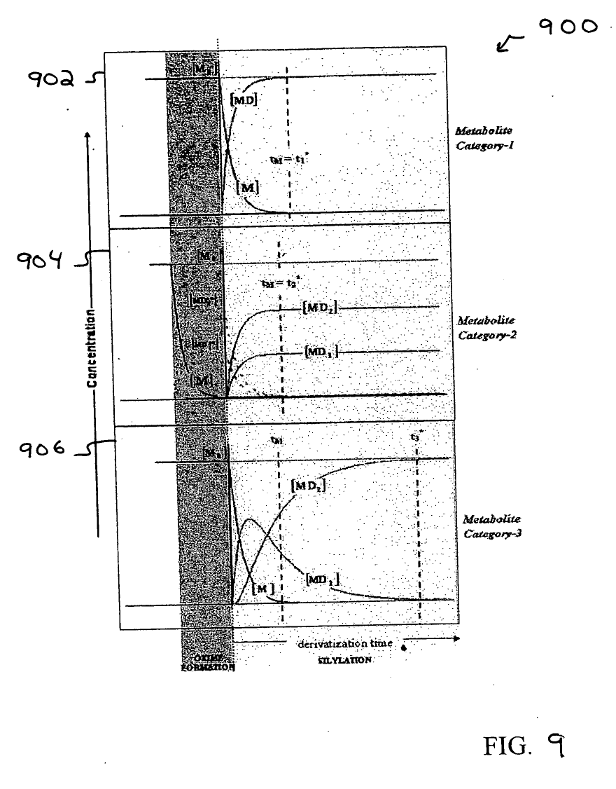

FIG. 7 is a table comparing advantages and disadvantages of gas chromatography-mass spectrometry (“GC-MS”), liquid chromatography-mass spectrometry (“LC-MS”), and nuclear magnetic resonance (“NMR”). Metabolomic profiling using GC-MS has emerged as an advantageous high-throughput methodology for the acquisition of the metabolomic fingerprint of a biological system. In GC-MS metabolomic analysis, an original metabolite sample is initially subjected to a derivatization process, which is discussed in greater detail below, to convert the mostly non-volatile metabolites into their volatile and thermally stable derivatives. Therefore, the metabolomic profile that is finally measured corresponds to the derivative and not the original sample. Two types of biases are introduced during the entire data acquisition process, thereby hindering comparison among different samples. In this case, appropriate data normalization/correction is required before conducting any further analysis for the identification of relevant patterns of biological significance. The first type of biases are common among all analytical techniques used in metabolomics and are accounted for through the use of an internal standard, as previously described. However, the second type of biases is specific to metabolomic analysis using GC-MS or any other derivatization-separation-molecular ID and quantification process, because they result from the derivatization process itself. For them, no high-throughput data correction and normalization strategy has been proposed, neither in the context of metabolomics nor in the context of any other chemical analysis, that uses a derivatization-separation-molecular ID and quantification process. The first strategy of this kind is proposed by the present invention. The first type of bias, which is not limited to GC-MS metabolomics, changes the size of the proportionality among profiles. In other words, while performing GC-MS analysis for a large number of samples, there could be errors during the experimental or instrumental limitations, which will vary from one sample to the other. This variation is normalized using known concentration of an internal standard compound, which is externally added to all the biological samples and hence concentration is expected to be the same for all the samples. Normalization using internal standard/s is the common normalization technique used so far.

The present data correction method and system takes into consideration that, two derivative metabolomic profiles of the same biological system, but at different cellular states, might not be directly comparable, due to the presence of the second type of biases. The reasons behind this type of biases are twofold: (a) some metabolites form more than one derivative; and (b) the derivative profile depends on the composition of the original sample and the duration of the derivatization. Specifically, in order to provide high-throughput of the GC-MS process, as described in greater detail below, it is often impractical to wait until complete conversion of all metabolites to their single derivative form, if this is applicable. In addition, the time required for complete equilibrium of all metabolites jeopardizes the integrity of the derivatized biological sample due to degradation of some derivatives. Moreover, in some cases, complete conversion of the original metabolite to a single derivative cannot be achieved due to the complexity of the molecules and the limited number of derivatization agents that may be practically used to produce the derivatives. Thus, the retrieved data is potentially distorted from a one-to-one relationship with the original sample. Moreover, the metabolomic profile of the same original sample might be different if measured at different derivatization times. In addition, the metabolomic profile of a particular metabolite of the same concentration in two different samples might be qualitatively and quantitatively different even if measured at the same derivatization time, if the compositions of the samples are different. In other words, by more fully understanding the relationship between the observed derivatives in the retrieved data set and the original sample, the data may be corrected to more accurately quantify the original samples. As an additional benefit, this will enable the identification of currently unknown peaks in the GC-MS spectrum. In fact, application of the present method and system for data correction has enabled the annotation of eighteen (“18”) amino acid derivative peaks that, had to-date, either not been reported, or considered as unknown in public databases.

To-date, metabolomic profiling has been mainly used to differentiate between various cellular states and/or identify an environmental or genetic phenotype. When the objective is to differentiate between various cellular states, it is current practice to compare the entire metabolomic profile for each cellular state while considering each peak area as independent from other peak areas. Further, when the objective is to identify an environmental or genetic phenotype, practice has been to consider and/or present only one derivative, often the largest peak area observed in the MS spectra, as representative of a metabolite's concentration. However, both practices might introduce biases and lead to erroneous conclusions.

The present data correction method and system takes into consideration that, two derivative metabolomic profiles of the same biological system, but at different cellular states, might not be directly comparable, due to presence of the second type of biases. This condition may be present even if the two derivative metabolomic profiles have been measured at the same derivatization time and there has been one-to-one relationship between the original and the derivative metabolomic profiles. Further the present method also suggests a data validation method which will allow verification for constant GC-MS operating conditions, which is a pre-requisite for metabolomic data analysis.

The present data correction method and system further considers that there is not a one-to-one relationship between the original and the derivative profiles. The most commonly used derivatives in GC-MS metabolomics are the trimethylsilyl (“TMS”) and methoxime (“MEOX”)—derivatives. Thus, there are three identified metabolite categories, as set forth below, in the context of the most commonly used derivatives in GC-MS metabolomics. However, only the below Category-I derivatives form a one-to-one correspondence with the original metabolite.

Category-1: Metabolites which form one and only one detectable derivative upon reaction with a derivatizing agent, where the derivative undergoes no further reaction. In this case, the metabolite concentration falls until time t_{M}, at which time the metabolite is essentially gone. Simultaneously, the derivative concentration increases until time t_{M}. After time t_{M}, a steady state is achieved, with a constant concentration of derivative which can be assumed to be equal to the initial metabolite concentration. Hence for Category-1 metabolites, there exists a one-to-one correspondence between the original metabolite and its derivative concentration if the samples are allowed to analyze after time t_{M}.

Category-2: Metabolites which form two isomeric derivatives simultaneously through parallel reactions with a derivatizing agent. In this case, the metabolite concentration falls until time t_{M}. Simultaneously, the concentrations of the various derivatives increase until time t_{M}. After time t_{M}, a steady state is achieved, with a constant concentration of each derivative. At any stage however, the ratio of the concentration of derivatives which are formed through parallel reaction are always in a constant ratio, proportional to their individual reaction rates. Thus for Category-2 metabolites, each original metabolite concentration is represented by two derivative forms, both of which have concentrations which are directly proportional to the original metabolite concentration. In this case, the total concentration of all derivatives at a time t_{M} can be assumed to be equal to the initial metabolite concentration.

Category-3: Metabolites which form multiple derivatives sequentially upon reaction with a derivatizing agent. For example, the metabolite may react with a derivatizing agent to form a first derivative. The first derivative then reacts to form a second derivative, either by rearrangement of the first derivative, or through reaction between the first derivative and derivatizing agent. In this case, the metabolite concentration falls until time t_{M}, at which time the metabolite is essentially gone. After time t_{M}, both the first and second derivatives are present in solution, with a total concentration of all derivatives which can be assumed to be equal to the initial metabolite concentration [M_{O}]. However, a steady state concentration is not achieved at time t_{M}; rather, the concentration of the first derivative decreases as it is converted to the second derivative, while the concentration of the second derivative increases.

The preceding discussion assumes that the rate of reaction of the first derivative is comparable to or slower than the rate of reaction of the metabolite with the derivatizing agent. If the first derivative reacts much more rapidly than the metabolite, this becomes indistinguishable from Category-1, with the second derivative as the sole detectable derivative. Of course, even though a steady state concentration is not achieved at time t_{M}, mass is conserved during the reaction.

The above observation is true for metabolites containing at least one amine (—NH2) group, because the rate of derivatization of the amine group is much slower as compared to carboxylic (—COOH) and hydroxyl (—OH) groups. Further, each amine group contains two active hydrogen atoms, and the rate of reaction for the formation of the second derivative form (—N(TMS)2) is slower as compared to the first derivative form (—NH(TMS)). This difference in reaction rates leads to the formation of multiple derivatization forms.

Of the three categories set forth above, only the Category-1 forms a single derivative upon reaction with a common derivatizing agent, such as trimethylsilyl (“TMS”), methoxime (“MEOX”), or heptafluorobutyrate derivatives.

In view of the above, multiple derivative peaks of the Category-2 and Category-3 metabolite classes cannot be considered as independent in any statistical analysis. In addition, there remains a question as to which of the derivative peak areas should be included as representative of the original metabolite's concentration. For Category-2 metabolites, two derivatives of constant concentration ratio are formed throughout the derivatization process. In this case, only one of the two derivative peak areas, preferably the largest and less susceptible to noise, is preferably used to represent the original metabolite concentration. The other smaller derivative peak area which represents a duplicate measurement of the original peak area is removed before performing data analysis. Moreover, because the peak areas of the two metabolite derivatives form a constant ratio which depends only on derivatization rate and GC-MS conditions, the ratio of the two derivatization forms peak areas should remain constant as long as the GC-MS conditions and derivatization conditions remain constant, both of which are pre-conditions before performing any statistical analysis. Thus the constant ratio between the peak areas of derivatization forms of Category-2 metabolites provides a robust criterion for data validation prior to any analysis.

Category-3 metabolites, generally comprise any metabolite with at least one amine (—NH2) group, and thereby include all amino acids. As set forth above, because the concentrations of second and third derivatives are sequentially formed at a time greater than t_{M}, peak area of the single derivatization form does not represent the original metabolite concentration, as is currently practiced. The original metabolite concentration, after time t_{M} is the sum of all its' derivative forms present in the solution. Hence the original metabolite concentration is represented by the “cumulative peak area” of its derivative forms which is the weighted sum of the multiple observed derivative peak areas. It is this “cumulative” area which should be used in any statistical analysis instead of the current practice of using a selected single derivative form or using multiple derivative forms as independent measurements.

In accordance with the present invention, estimation of weight values of identified metabolite derivatives is used in the quantification of a “cumulative” peak area for any metabolite in Category-3. For this, only one biological or synthetic sample of similar composition should undergo a repetitive measurement process at different derivatization forms. From the data obtained from these repeated measurements, all of which represent the same biological samples, the weight values can be estimated. Once these weights are estimated they remain constant as long as the GC-MS conditions remain constant. Thus they can then be used to correct the metabolomic profiles of all other biological samples being analyzed, by replacing individual derivatization forms with their “cumulative” peak areas.

The entire process of derivatization, optimization of derivatization time t_{M}, data validation using the constant ratio of Category-2 metabolite derivatization forms, and estimation of the weight values and “cumulative” peak areas for Category-3 metabolites are described in greater detail in the following sections.

Creation of the Metabolite Derivatives

The relationship between the observed derivatives in the retrieved data set and the original metabolite sample, in the context of which the need for the present invention is discussed, will be presented for the most commonly used derivatives in GC-MS metabolomics, the trimethylsilyl (“TMS”) and methoxime (“MEOX”)—derivatives. A TMS-derivative metabolite profile is the product of the reaction of a metabolite mixture with a silylating agent, e.g. the N-methyl-trimethylsilyl-trifluoroacetamide (“MSTFA”). However, the method and system of the present invention is not limited to this derivatizing agent but could be accordingly applied to other silylating agents that may be selected to act in a TMS-derivatization process. Examples of other silylating agents include: trimethylsilyl chloride (“TMSCl”); hexamethyldisilazane (“HMDS”), N-trimethylsilyl-imidazole (“TMSI”), and [3-(2-aminoethyl)aminopropyl]trimethoxysilane (“AEAPTS”). If desired, silyl compounds having branched alkyl groups, such as tert-butyl(dimethyl)silyl compounds, or cyclic alkyl groups, such as cycloalkylsilyl compounds, may be used. Embodiments of the present invention are also applicable to the derivatization of biological materials with other agents, including oximes, such as methoxime hydrochloride, or acid derivatives. For example, a methodology of the present invention may be applied with equal facility to: derivatization of amino acids and hydroxy acids with N-methyl-trimethylsilyl-trifluoroacetamide; derivatization of carbonyl compounds with oximes; and/or derivatization of saccharides with heptafluorobutyric anhydride.

FIG. 8 illustrates a flow chart 800 of operations for metabolomic analysis according to an embodiment of the present invention. In operation 801, the dried metabolite mixture is obtained from the original biological sample, based on a specific extraction procedure. In operation 802, the dried metabolite mixture is resolved in a particular solvent; a derivatizing agent is added to the metabolite solution to form the solution of the metabolite derivatives. According to a preferred embodiment, the derivatizing agent is a silylating agent, and preferably N-methyl-trimethylsilyl-trifluoroacetamide (“MSTFA”). The solution is a liquid, and it is injected using an autosampler to injection port 110—where it is vaporized into gas form in the first chamber of the gas chromatograph. The requirement for GC is that the injected solution contains volatile compounds.

In operation 804, the mixture of the metabolite derivatives is introduced into a separation-molecular ID and quantification process, which can detect molecules with the properties of the metabolite derivatives, but not of the original metabolites, such as gas chromatography-mass spectrometry (“GC-MS”). The obtained chromatograph corresponds to the mixture of the metabolite derivatives.

Next, in operation 806, a determination is made whether the measured profile is in a one-to-one directly proportional relationship with the metabolite mixture. Based upon this determination, the acquired data are corrected from derivatization biases to form the final dataset that directly corresponds to the original metabolite mixture and could be used for further analysis. According to many prior methodologies, operation 806 either is entirely skipped or performed sub-optimally. As described in greater detail below, a one-to-one relationship is not present due to the limitations of the derivatization process, and hence as shown in operation 808, data correction is performed on the multiple derivative metabolomic profiles in accordance with the present invention. The present invention thus provides a systematic methodology for operations 806 and 808.

Once this data correction has been performed, in operation 810, using the corrected metabolomic profiles, statistical analysis using multivariate statistical analysis tools like Hierarchical Clustering (“HCL”) analysis or Principal Component Analysis (“PCA”) or k-Means Clustering (“KMC”) Analysis is performed to identify differences in metabolic states of the biological sample. Further hypothesis testing such as with t-Test, ANOVA, or Significant Analysis of Microarrays (“SAM”) are also performed for identifying metabolites which show differential expression between two or more biological states.

FIG. 9 illustrates a graph 900, including sub graphs 902, 904, and 906 showing variations in concentrations for an original metabolite and three categories of metabolite derivatives as a function of time. Based on the number and type of their TMS-derivatives, metabolites can be grouped into three categories. Category-1 is illustrated in sub-graph 902, and represents metabolites forming only one derivative MD. Category-2 is illustrated in sub-graph 904, and represents metabolites forming two derivatives, MD₁ and MD₂, differing in the position of the oxime group. Category-3 is illustrated in sub-graph 906, and represents metabolites forming multiple derivatives, differing in the number of TMS-groups or chemical formula (here the case of two sequentially related derivatives MD₁ and MD₂ is depicted). The final steady-state in each Category is independent of the derivatization kinetics.

The symbols [M], [MD_{1,2}^{ox}], and [MD_{1,2}] represent the concentration of: metabolite M, the 1^{st} and 2^{nd} oxime-intermediate, and 1^{st} and 2^{nd} TMS-derivative, respectively, at any given derivatization time t. The symbol [Mo] represents the concentration of metabolite M in the original sample. The symbol t_{M} represents time (after addition of the derivatizing agent) for the complete transformation of the original metabolite M or the oxime-intermediates in the case of a Category-2 metabolite; and tⱼ*(j=1, 2, 3) represents time (after addition of the derivatizing agent) for the complete derivatization of a Category-j metabolite.

FIG. 9, sub-graph 902 illustrates first order kinetics of a metabolite M reacting with a derivatizing agent MSTFA to form one derivative MD according to the following equation.

$$M + MSTFA {\to }^{k} MD \qquad EQ . 1$$

In the above formula, M represents the original metabolite to be analyzed, MSTFA represents the derivatizing agent, k represents the derivatization rate constant, and MD represents the derivative. In this case, the derivatizing agent is a silylating agent, N-methyl-trimethylsilyl-trifluoroacetamide. Independent of the order of the derivatization kinetics, the derivative concentration [MD] becomes equal to the initial concentration [Mo] after derivatization time t₁*. In this case, t₁* coincides with the time t_{M} for complete transformation of the original metabolite M.

In order to compare the concentration of a Category-1 metabolite among various samples, barring changes in the GC-MS operating conditions, the TMS-derivative metabolomic profile of all samples should have been acquired after derivatization time t₁*. Even though it seems that the same relative result would have been obtained if the samples had been acquired at a derivatization time shorter than time t₁*, as long as the derivatization time was the same for all samples, this is not necessarily true. The composition of the original sample might change the derivatization rate constant k for a particular Category-1 metabolite among the various samples, as long as the concentration of all other reagents participating in the derivatization process remains the same.

Thus, after a derivatization time t>t_{M}, the following equation describes the reaction of a Category-1 metabolite, as illustrated in sub-graph 902:
[Mo]=[MD]=w_{MD}*RPA_{MD} EQ. 2
where [Mo] is the original metabolite concentration and [MD] is the concentration of the metabolite derivative. RPA_{MD} is the measured relative peak area of metabolite derivative MD as observed from the MS spectra data. As set forth above, because the observed MS spectra includes the peak area of the standard PA_{standard}, the relative peak area RPA_{MD} is of interest because it represents only the peak area corresponding to the metabolite derivative MD. The symbol w_{MD} represents the relative response ratio of the metabolite derivative MD. The relative response ratio w_{MD} may be mathematically derived from the other equation elements as set forth below:
w_{MD}=[M]/RPA_{MD} EQ. 3

Thus, w_{MD} represents the constant of proportionality between the original metabolite concentration [M] and its measured signal, i.e. the measured relative peak area RPA_{MD}. The value w_{MD} is thus expected to be constant for a given instrument as long as the instrument conditions remain constant. Further, in case of GC-MS analysis, RPA_{MD} depends upon the choice of the marker ion (mass-to-charge ratio value m/z) used for quantification of the metabolite and its fragmentation pattern, and is different for different metabolites. The relative response ratio w_{MD} has a different value for each metabolite derivative peak form.

FIG. 9, sub-graph 904, illustrates metabolites forming two derivatives (MD₁ and MD₂) differing in the position of the oxime group: 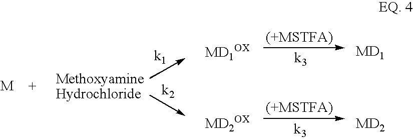
where, k₁, k₂ represent the rate constants for oxime formation; M₁^{ox}, MD₂^{ox} represent first and second intermediate methoxime derivatives; MSTFA represents the derivatizing agent N-methyl-trimethylsilyl-trifluoroacetamide; k₃ represents the derivatization rate constant; and MD₁ and MD₂ represent first and second derivatives. The derivatizing rate constant k₃ is equivalent for each of the derivatives MD₁ and MD₂ and therefore is represented as the same constant k₃ in the above equation.

According to an embodiment, the derivatization constant k₃ is a silylating constant corresponding to MSTFA. Independent of the oxime formation and derivatization kinetics order, the MD₁ and MD₂ concentrations, i.e. [MD₁] and [MD₂], are of constant ratio

$${k}_{o} = \frac{{k}_{1}}{{k}_{2}}$$

and the concentrations [MD₁] and [MD₂] reach final values, summing up to the initial concentration [Mo] at derivatization time t₂*. In this case, time t₂* coincides with the time t_{M} for the complete transformation of the intermediate methoxime derivatives MD₁^{ox}, MD₂^{ox},i.e. MD_{1,2}^{ox}.

Thus, the MD₁ and MD₂ peak areas, as observed in the output of the mass spectrometer, are not independent. The MD₁ and MD₂ peak areas are therefore preferably not considered to be independent in any multivariate statistical analysis. In other words, because the concentrations [MD₁] and [MD₂] are mathematically related, only one of the concentrations, preferably the largest and less susceptible to noise, should be used to determine the original metabolite concentration. Moreover, similar to the Category-1 metabolites, in order to compare the concentration of a Category-2 metabolite among various samples, barring changes in the GC-MS operating conditions, the TMS-derivative metabolomic profile of all samples should be acquired after derivatization time t₂* when the metabolite concentrations [MD₁ ] and [MD₂] have reached a steady state. In addition, the constant ratio between the two derivative peak areas of a Category-2 metabolite M depends only on kₒ, which is described in greater detail below. The value kₒ is a characteristic of the original metabolite and the GC-MS operating conditions. As such, this Category-2 metabolite ratio

$${k}_{o} = \frac{{k}_{1}}{{k}_{2}}$$

should be used as the criterion to verify whether the GC-MS operating conditions remained constant throughout data acquisition.

Thus, after a derivatization time t>t_{M}, the following equations describe the reaction of sub-graph 904:
[M_{O}]=[MD₁]+[MD₂] EQ. 5
where [M_{O}] is the concentration of the original metabolite; [MD₁] is the concentration of the first metabolite derivative; and [MD₂] is the concentration of the second metabolite derivative.

The concentrations of the metabolite derivatives are then present according to the following formula:

$$\frac{[ {MD}_{1} ]}{[ {MD}_{2} ]} = \frac{{k}_{1}}{{k}_{2}} = {k}_{0} = \frac{{w}_{{MD}_{1}} * {RPA}_{{MD}_{1}}}{{w}_{{MD}_{2}} * {RPA}_{{MD}_{2}}} \qquad EQ . 6$$

where [MD₁] is the concentration of the first metabolite derivative; [MD₂] is the concentration of the second metabolite derivative; k₁ and k₂ represent the rate constants for oxime formation; k_{O} represents a ratio of k₁/k₂; RPA_{MD1} is the relative peak area of the first metabolite derivative MD₁; w_{MD1} is the relative response ratio of the relative concentration of the first metabolite derivative MD₁ and its measured relative peak area RPA_{MD1}; RPA_{MD2} is the relative peak area of the second metabolite derivative MD₂; and w_{MD2} is the relative response ratio of the relative concentration of the second metabolite derivative MD₂ and its measured relative peak area RPA_{MD2}.

The original metabolite concentration [M_{O}] therefore corresponds to the concentration of the second metabolite derivative [MD₂] as follows:

$$[ {M}_{O} ] = ( 1 + {k}_{0} ) * [ {MD}_{1} ] = ( 1 + \frac{1}{{k}_{0}} ) * [ {MD}_{2} ] \qquad EQ . 7$$

where [M_{O}] is the concentration of the original metabolite, k_{O} represents a ratio of k₁/k₂; [MD₁] represents the concentration of the first metabolite derivative MD₁; and [MD₂] represents the concentration of the second metabolite derivative MD₂.

Thus, the relative peak areas as observed from the MS spectra of the first metabolite MD₁ and the second metabolite MD₂ form a constant throughout the derivatizing process as follows:

$$\frac{{RPA}_{{MD}_{1}}}{{RPA}_{{MD}_{2}}} = {k}_{0} * \frac{{w}_{{MD}_{2}}}{{w}_{{MD}_{1}}} = {k}_{M}^{*} = constant \qquad EQ . 8$$

where RPA_{MD1} is the relative peak area of the first metabolite derivative; RPA_{MD2} is the relative peak area of the second metabolite derivative; kₒ represents a ratio of k₁/k₂; w_{MD2} is the relative response ratio of the relative concentration of the second metabolite derivative MD₂ and its measured relative peak area RPA_{MD2}; w_{MD1} is the relative response ratio of the relative concentration of the first metabolite derivative MD₁ and its measured relative peak area RPA_{MD1}; and k_{M}* is constant representing the ratio of the two derivatization form peak areas, which should remain constant as long as GC-MS conditions and derivatization conditions remain constant.

According to an embodiment, the quality of the subject separation-molecular ID and quantification process may be determined. The Category-2 metabolite reaction rate ratio

$${k}_{o} = \frac{{k}_{1}}{{k}_{2}}$$

is a mathematical constant, characteristic of the particular metabolite, and independent of the operating conditions of the separation-molecular ID and/or quantification process (in particular, the GC-MS process). In a perfect scenario, when the operating conditions of the separation-molecular ID and/or quantification process (in particular, the GC-MS process) do not change throughout repetitive runs, the relative response ratios w_{MD1} & w_{MD2}, which depend on these conditions, should remain constant as a function of time. Thus, in a perfect system, the ratio between the two relative peak areas of a Category-2 metabolite

$${k}_{M}^{*} = \frac{{RPA}_{MD 1}}{{RPA}_{MD 2}}$$

should remain constant as a function of time. However, due to changes inherent in the operating conditions of the separation-molecular ID and quantification process (in particular, the GC-MS process), the relative response ratios w_{MD1} & w_{MD2} may change. Consequently, the ratio between the relative peak areas of a Category-2 metabolite

$${k}_{M}^{*} = \frac{{RPA}_{MD 1}}{{RPA}_{MD 2}}$$

may change. In order to verify quality of the separation-molecular ID and quantification process, an amount of change in k_{M}* is determined and compared with acceptable amount of change provided by the equipment manufacturer for the particular separation-molecular ID and/or quantification process. This acceptable amount of change may vary from 5% up to 25%, depending upon the equipment used and the type of materials under investigation. Accordingly, for Category-2 metabolites, the relative peak areas of at least two Category-2 derivatives may be repeatedly measured, and the corresponding mathematical ratio

$${k}_{M}^{*} = \frac{{RPA}_{MD 1}}{{RPA}_{MD 2}}$$

repeatedly calculated. A change in the mathematical ratio

$${k}_{M}^{*} = \frac{{RPA}_{MD 1}}{{RPA}_{MD 2}}$$

may then be determined and expressed as a percentage for comparison with the acceptable amount of change provided by the equipment manufacturer.

FIG. 9, sub-graph 906, illustrates metabolites forming multiple derivatives, differing in the number of TMS-groups or chemical formula:

$$\begin{matrix}M + MSTFA {\to }^{k} {M ( TMS )}_{x} {{\to }^{( + MSTFA )}}_{{k}_{1}} {M ( TMS )}_{x + 1} {{\to }^{( + MSTFA )}}_{{k}_{n}} {M ( TMS )}_{x + n} \\ or & EQ . 9 \\ M + MSTFA {\to }^{k} {M ( TMS )}_{x} {{\to }^{( + MSTFA )}}_{{k}_{1}} {M ( TMS )}_{x + 1} {{\to }^{( + MSTFA )}}_{{k}_{n}} M\_new {( TMS )}_{?} & EQ . 10\end{matrix}$$

where M represents the original metabolite; MSTFA represents the derivatizing agent N-methyl-trimethylsilyl-trifluoroacetamide; k, k₁, . . . kₙ represent derivatization rate constants; and x represents the number of TMS-groups after all carboxyl (—COOH) and hydroxyl (—OH) groups of the original metabolite M have reacted.

Category-3 metabolite reactions comprise metabolites containing at least one amine (—NH₂) group. The protons in (—NH₂) react sequentially and slower than those in carboxyl (—COOH) and hydroxyl (—OH) groups. Initially, on addition of MSTFA, by derivatization time t_{M} all the carboxyl (—COOH) and hydroxyl (—OH) groups undergo TMS derivatization forming the first M(TMS)ₓ derivative form. Each proton in the amine group will then react sequentially forming subsequent derivatization forms M(TMS)ₓ₊₁, M(TMS)ₓ₊₂, . . . M(TMS)ₓ₊ₙ with increasing number of TMS groups. Since each derivative form is a separate chemical entity, they have different chromatographic properties and will hence give rise to individual peaks in the GC-MS chromatogram. In some cases as depicted in the second set of reactions, a particular M(TMS)ₓ₊ⱼ derivative might undergo chemical transformation (like cyclization through loss of TMS-OH molecule), as depicted in the second set of sequential reactions, forming a derivative which no longer contains the original metabolite form. The second set of reactions also occur sequentially—but in this case the difference is not only in the number of derivatization forms as is the case in the first set, but also the metabolite itself under goes transformation—e.g. Glutamate 3 TMS gets converted to Pyroglutamate 2 TMS.

Thus for a Category-3 metabolite M, independent of the derivatization kinetics, only one derivative MD₂, with a concentration equal to the original concentration of metabolite M in the original sample, will be present after the completion of derivatization at time t₃*. As illustrated in sub-graph 906, the time t₃* represents a steady state of concentrations [MD₁] and [MD₂], wherein metabolite MD₁ has completely transformed into metabolite MD₂. However, time t₃* does not coincide with, but is longer than the time t_{M} for the complete transformation of the original metabolite M. At any other derivatization time shorter than time t₃*, more than one derivative of M, i.e. MD₁ and MD₂, will be present in the metabolomic profile. These derivative peak areas, as observed in the MS spectra, are not independent and should not be considered as such in multivariate statistical analysis. In contrast to the two derivatives for Category-2 set forth above, for derivatization times greater than t_{M} the concentration of Category-3 metabolite derivatives are not each directly proportional to the concentration of the original metabolite M. It is the sum of the concentrations of the Category-3 metabolite derivatives that is proportional to the concentration of the original metabolite M. Hence, it is not correct for any of the derivative peak areas observed from the MS spectra to be used individually as representative of the original metabolite M's concentration. An estimation of a cumulative peak area, representing the weighted sum of the peak areas of all Category-3 metabolite derivatives at any given derivatization time is therefore needed. According to an embodiment of the present invention, a method and system are presented to enable the estimation of this “cumulative” peak area for derivatization times greater than t_{M}.

As illustrated in FIG. 9, sub-graph 906, a Category-3 metabolite having an initial concentration [M_{O}] reacts with the derivatizing agent. The metabolite concentration [M] diminishes toward zero as derivatives [MD₁] and [MD₂] are formed. The derivatives [MD₁] and [MD₂] are formed through sequential reactions. At a time t_{M}, the metabolite M having a concentration [M] has substantially reacted with the derivatizing agent. According to an embodiment, the term “substantial” means that the metabolite M has reacted at least 80% with the derivatizing agent. According to a more preferable embodiment, the term “substantial” means that the metabolite M has reacted at least 95% with the derivatizing agent. According to a preferred embodiment, the term “substantial” means that the amount of metabolite M that has not reacted with the derivatizing agent is negligible for computational analysis, and is therefore below a noise threshold of the process.

The metabolites under investigation are biological compounds, and are therefore subject to degradation. As illustrated in FIG. 9, sub-graph 906, the time t₃* represents a steady state of concentrations [MD₁] and [MD₂]. However, this time t₃* may be on the order of 30+ hours. At these long derivatization times, the derivatives of the biological compounds under investigation may be subject to degradation. Thus, by conducting measurements between the time t_{M} to time t₃*, the prospects of degradation of the compounds will be substantially minimized. Thus, according to a preferred embodiment, the relative peak areas for Category-3 metabolite derivatives are measured before the metabolite derivatives have substantially degraded.

Thus, after a derivatization time t>t_{M}, the following equations describe the reaction of sub-graph 906:

$$[ {M}_{O} ] = {\sum }_{i = 1}^{n} [ {MD}_{i} ] = {\sum }_{i = 1}^{n} {w}_{i}^{M} * {RPA}_{{MD}_{i}} \qquad EQ . 11$$

where [M_{O}] is the concentration of the original metabolite; [MDᵢ] is the concentration of each of a plurality of derivatives i=1, 2, . . . n; wᵢ^{M} is the relative response ratio of the relative concentration of MDᵢ with its measured relative peak area RPA_{MDi} with respect to the internal standard; and RPA_{MDi} is the relative measured peak area of MDᵢ with respect to the peak area of the internal standard.
High-Throughput Data Correction

Based on the metabolite categorization described in the previous section, if a biological sample contains metabolites P, Q and R, respectively, in each of the Categories 1, 2, and 3, then the derivative peak areas and the original concentration profiles are in one-to-one directly proportional relationship, only if: (a) one of the two peak areas of Category-2 metabolites is considered; and (b) the metabolomic profile is obtained at derivatization time T, where:
T=max {T₁*, T₂*, T₃} EQ. 12
and
T₁*=max_{i=1,2, . . . ,P}{t_{1,i}*};
T₂*=max_{j=1,2, . . . ,Q}{t_{2,j}*};
T₃*=max_{l=1,2, . . . ,R}{t_{3,l}*} EQ. 13
The proportionality ratio between the two profiles depends then only on the GC-MS operating conditions.

While T would have been the optimal derivatization time for GC-MS metabolomics analysis, the complete derivatization time for Category-3 metabolites T₃* might be longer than 30 hours. This time T₃* is too great for high through-put metabolomic analysis. Besides the practical difficulties of an experimental protocol of this long duration, derivative degradation might occur at such long derivatization times. The maximum derivatization time for all Category-1 metabolites T₁*, and the maximum derivatization time for all Category-2 metabolites T₂* is usually on the order of 2-5 hours. Likewise, the time t_{M} for complete transformation of an original Category-3 metabolite R into varying, but related multiple derivatives is also in the order of 2-5 hours. Thus, a time T_{M} being the maximum of T₁*, T₂* and the maximum of all R t_{M}'s, is also in the order of 2-5 hours. It follows that an optimized derivatization protocol would refer to times slightly greater than T_{M}. At this time T_{M}, all original metabolites have been completely transformed into their derivatives, i.e. their concentration in the derivatized sample is substantially equal to zero.

In view of the above, for Category-1 metabolites, derivatization has been completed and there is a one-to-one correspondence between the metabolite derivative and the original metabolite. For Category-2 metabolites, derivatization has also been completed and two relative peak areas represent the original metabolite. Barring degradation, the measured peak profile of Category 1 and 2 metabolites is not expected to change at times longer than T_{M}. At times slightly greater than T_{M}, the peak profile of Category-3-metabolites might vary significantly depending at which time after T_{M} it is measured (see FIG. 9, sub-graph 906). If this variation is not properly accounted for, differences due only to derivatization kinetics could be falsely assigned biological significance. In other words, if one tries to measure metabolite concentrations before the completion of the derivatization reaction of the Category-3 metabolites, and does not account for the changes occurring in Category-3 metabolites, erroneous data and conclusions may be reached.

In accordance with the quantitative metabolomic profiling analysis according to the present invention, the peak profile of Category-3 metabolites is addressed in the present invention. These Category-3 metabolites are important constituents of metabolomic analysis. By way of example, the largest to-date publicly available retention-time library of TMS-derivatives is the Metabolite Mass Spectra Library (“MPL”) provided by Max Planck Institute of Molecular Plant Physiology, which is publicly available on the internet. The MPL provides that out of 167 polar metabolites for which at least one derivative has been identified, 47 contain at least one (—NH₂)-group. Among those are the amino acids, a class of major significance, because they are often used as markers of biological change.

The method and system of the present invention is valid for derivatization times longer than T_{M}, if a certain derivatization time needs to be selected for the high-throughput experimental protocol, as set forth below. Specifically, since mass is conserved in a chemical reaction network, for a particular Category-3 metabolite, “1,” at any derivatization time longer than t_{M,1}, the concentrations of all its present derivatives sum up to its concentration in the original sample [M_{O}] as shown below:
[M₀]=[MD₁]+ . . . +[MDₙ] EQ. 14
where n is the number of the metabolite 1's derivatives observed throughout the measured derivatization period under given analytical conditions; MDᵢ is the i-th derivative of metabolite “1.”

The above equation can then be transformed in terms of relative concentrations with respect to an internal standard (which belongs to Category-1) as follows:

$$\frac{[ {M}_{0} ]}{[ {Co}_{IS} ]} = \frac{[ {MD}_{1} ] + … + [ {MD}_{n} ]}{[ {Co}_{ISD} ]} = \frac{[ {MD}_{1} ]}{[ {Co}_{ISD} ]} + ... + \frac{[ {MD}_{n} ]}{[ {Co}_{ISD} ]} \qquad EQ . 15$$

where Co_{IS} is the known concentration of added internal standard (“IS”) in the original sample and Co_{ISD} is the known concentration of its derivative form after time T_{M}.

For all peaks detected using GC-MS within its dynamic range of operation, the relative concentration of each derivative form [MDᵢ] of metabolite M is proportional to its relative peak area as shown below:

$$\frac{[ {MD}_{i} ]}{[ {Co}_{ISD} ]} = {w}_{i}^{M} * \frac{{PA}^{{MD}_{i}}}{{PA}^{ISD}} = {w}_{i}^{M} * {RPA}^{{MD}_{i}} \qquad EQ . 16$$

where wᵢ^{M} is the relative response ratio of the relative concentration of MDᵢ with respect to its measured relative peak area RPA at any given derivatization time. The relative response ratio wᵢ^{M} depends only on the GC-MS operating conditions and the selected MDi marker ions. Thus combining EQ. 15 and 16 above, the original relative concentration of metabolite M_{O} can be obtained as:

$$\frac{[ {M}_{0} ]}{[ {Co}_{IS} ]} = {w}_{1}^{M} * {RPA}^{{MD}_{1}} + … + {w}_{n}^{M} * {RPA}^{{MD}_{n}} \qquad EQ . 17$$

Thus from the above equation it is clear that, after derivatization time T_{M}, the weighted summation of the RPA of each derivative form (with relative response ratio of each derivative form as its weight) represents the original relative concentration of the metabolite in the biological sample.

Therefore, barring change in the GC-MS operating conditions, if the same biological sample is measured at V different derivatization times longer than t_{M,1}, the following system of equations holds true for metabolite 1:

$$[ \begin{matrix}{RPA}_{{t}_{1}}^{{MD}_{1}} & ⋯ & {RPA}_{{t}_{1}}^{{MD}_{n}} \\ ⋮ & ⋯ & ⋮ \\ {RPA}_{{t}_{v}}^{{MD}_{1}} & ⋯ & {RPA}_{{t}_{v}}^{{MD}_{n}}\end{matrix} ] \cdot [ \begin{matrix}{w}_{1}^{M} \\ ⋮ \\ {w}_{n}^{M}\end{matrix} ] = [ \begin{matrix}\frac{[ {M}_{o} ]}{[ {Co}_{IS} ]} \\ ⋮ \\ \frac{[ {M}_{o} ]}{[ {Co}_{IS} ]}\end{matrix} ] \qquad EQ . 18$$

where n is the number of the first metabolite derivatives, MDᵢ is the i-th derivative of the first metabolite, RPAₜ_{ⱼ}^{MD}^{ᵢ} is the relative measured peak area corresponding to MDᵢ at derivatization time tⱼ, Co_{IS} is a known concentration of added internal standard (“IS”) in the first metabolite, [Mo] is the initial metabolite concentration, and wᵢ^{M} is the relative response ratio with respect to the internal standard.

Since the relative response ratio wᵢ^{M} depends only on the GC-MS operating conditions and the selected MDᵢ marker ions; barring changes in the latter, only one sample containing metabolite M should undergo the repetitive measurement process for the wᵢ^{M} estimation based on the above EQ. 18. If in this original metabolite sample concentration [Mo] is not known, any constant C could in theory be used instead. In metabolomic analysis, it is the relative change in the profiles, due to a particular perturbation, that matters. In this case, the estimated relative response ratios wᵢ^{M} would not represent the exact relative response ratio, but a certain proportionality ratio between the relative concentrations of MDi's and their measured relative peak areas.

Thus, according to an embodiment, in operation. 1104, EQ. 18 is solved using the measurements obtained in operation 1102 along with the original metabolite concentrations M_{O} for each Category-3 metabolite in the synthetic sample, if the synthetic sample was used in operation 802. Alternatively, according to an embodiment, EQ. 18 is solved using the measurements obtained in operation 802 with a certain constant C, if a biological sample of unknown composition was used in place of the synthetic sample. EQ. 18 is solved to estimate the wᵢ^{M} values for each Category-3 metabolite at the particular GC-MS operating conditions. To avoid mathematical artifacts, C should be selected to be of the same order of magnitude as the largest observed RPA^{MD}^{ᵢ} for each Category-3 metabolite in the measured samples of the particular batch. Accordingly, the following equation may be used in operation 1104:

$$[ \begin{matrix}{RPA}_{{t}_{1}}^{{MD}_{1}} & ⋯ & {RPA}_{{t}_{1}}^{{MD}_{n}} \\ ⋮ & ⋯ & ⋮ \\ {RPA}_{{t}_{v}}^{{MD}_{1}} & ⋯ & {RPA}_{{t}_{v}}^{{MD}_{n}}\end{matrix} ] \cdot [ \begin{matrix}{w}_{{MD}_{1}} \\ ⋮ \\ {w}_{{MD}_{n}}\end{matrix} ] = [ \begin{matrix}C \\ ⋮ \\ C\end{matrix} ] \qquad EQ . 19$$

where n is the number of the first metabolite derivatives, RPAₜ_{ⱼ}^{MD}^{ᵢ} is the relative measured peak area corresponding to the i-th derivative of metabolite M at the derivatization time tⱼ at which the j^{th} sample comprising metabolite M at concentration [Mⱼ] has been measured, and C is a constant. When a certain constant C is used in the regression analysis instead of the actual concentration [Mₒ], the estimated weights, wᵢ^{M}, would not represent the exact relative response ratio (inverse of the relative response factors) of metabolite M's derivatives, but a certain proportionality ratio between the relative concentrations of metabolite M's derivatives and their measured relative peak areas. In such conditions however it would be possible to perform only relative quantification which is of interest in most metabolomic profiling analyses.

An alternate experimental approach to obtain the values of the known right-hand side and the matrix elements in EQ. 18 would be to prepare V samples (V>n) of known metabolite concentration [M₁], [M₂], . . . [Mᵥ], respectively, and then run them through the GC-MS at the same or different derivatization times t₁, t₂, . . , tᵥ, respectively. In this case, the following system of equations holds true for any Category-3 metabolite M:

$$[ \begin{matrix}{RPA}_{{t}_{1}}^{{MD}_{1}} & ⋯ & {RPA}_{{t}_{1}}^{{MD}_{n}} \\ ⋮ & ⋯ & ⋮ \\ {RPA}_{{t}_{v}}^{{MD}_{1}} & ⋯ & {RPA}_{{t}_{v}}^{{MD}_{n}}\end{matrix} ] \cdot [ \begin{matrix}{w}_{1}^{M} \\ ⋮ \\ {w}_{n}^{M}\end{matrix} ] = [ \begin{matrix}\frac{[ {M}_{1} ]}{[ {Co}_{IS} ]} \\ ⋮ \\ \frac{[ {M}_{v} ]}{[ {Co}_{IS} ]}\end{matrix} ] \qquad EQ . 20$$

where n is the number of the first metabolite derivatives, MDᵢ is the i-th derivative of the first metabolite, RPAₜ_{ⱼ}^{MD}^{ᵢ} is the relative measured peak area corresponding to the i-th derivative of metabolite M at the derivatization time tⱼ at which the j^{th} sample comprising metabolite M at concentration [Mⱼ] has been measured, Co_{IS} is a known concentration of added internal standard (“IS”) in the first metabolite, and wᵢ^{M} is the relative response ratio with respect to the internal standard.

The estimated wᵢ^{M} values can then be used to determine the “cumulative” relative peak area of metabolite M in any other sample, as long as the GC-MS operating conditions (and the selected MDᵢ marker ions) remain constant, based on the following equation:

$${RPA}_{{s}_{a}}^{M} = {\sum }_{i = 1}^{n} {w}_{i}^{M} * {RPA}_{{s}_{a}}^{{MD}_{i}} \qquad EQ . 21$$

where RPAₛ_{ₐ}^{M} and RPAₛ_{ₐ}^{MD}^{ᵢ} represent, respectively, the cumulative relative peak area of metabolite M and the relative measured peak area MDᵢ for each derivative i=1, 2, . . . n, in sample Sₐ.

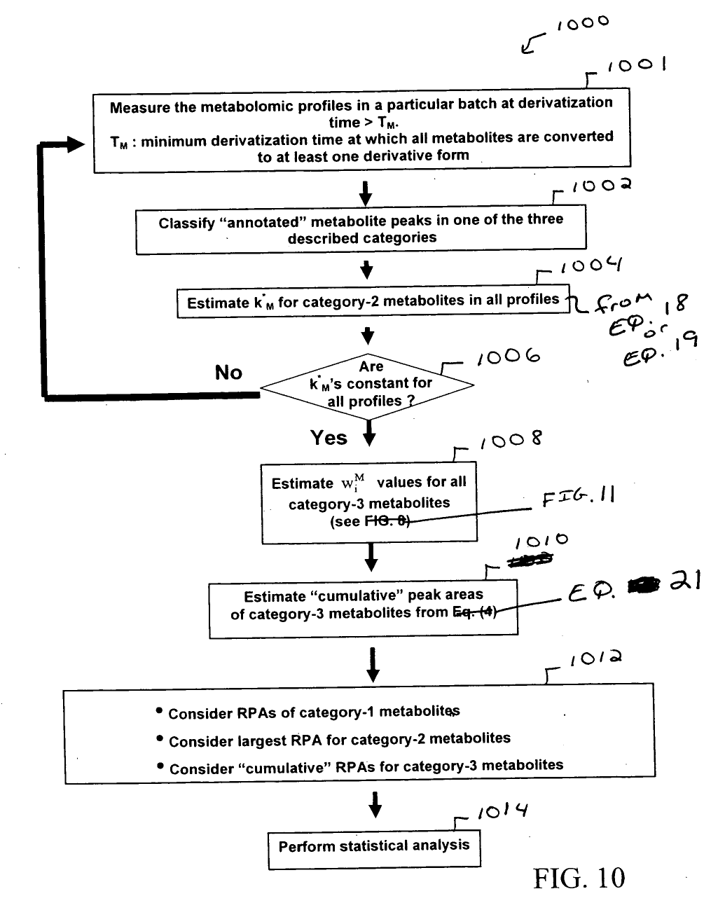

FIG. 10 illustrates a flow chart 1000 of a filtering/correction strategy for high-throughput metabolomic profiling according to a preferred embodiment of the present invention. As illustrated in FIG. 10, the strategy is presented barring changes in the GC-MS operating conditions. In operation 1001, metabolomic profiles are measured in a particular batch at a derivatization time equal or greater to T_{M} and relative peak areas are estimated with respect to an internal standard. While the identification of T_{M} is relatively easy when small groups of molecules are measured, in the case of high-throughput metabolomic analysis, some preliminary runs of the particular type of samples are required at various derivatization times. From the shape of the metabolite concentration profiles with respect to derivatization time, the time T_{M} could be approximately estimated. For example, in a sample of Arabidopsis thaliana liquid cultures that were 12-13 days old, time T_{M} was identified to be 6 hours after addition of MSTFA.

In operation 1002, “annotated” metabolite peaks in the observed profiles are identified and categorized in one of the three categories described above. The metabolomic profile of the known metabolites to be used for further analysis should then comprise: the relative peak areas of the Category-1 metabolites; one of the two peak areas of the Category-2 metabolites, preferably the largest and less susceptible to noise; and the estimated “cumulative” peak areas of Category-3 metabolites set forth in operation 1010 set forth below.

In operation 1004, for each Category-2 metabolite pair (differing in position of their oxime groups), the ratio of the RPA of the two derivatization forms is estimated, which is a constant for all samples being analyzed as shown below:

$$\frac{{w}_{1}^{M} * {RPA}^{{MD}_{1}}}{{w}_{2}^{M} * {RPA}^{{MD}_{2}}} = \frac{[ {MD}_{1} ]}{[ {MD}_{2} ]} = \frac{{k}_{1}}{{k}_{2}} = {k}_{o} \qquad EQ . 22$$

$$\frac{{RPA}^{{MD}_{1}}}{{RPA}^{{MD}_{2}}} = \frac{{w}_{2}^{M}}{{w}_{1}^{M}} * {k}_{o} = {k}_{M}^{*} \qquad EQ . 23$$

where k₁ & k₂ are rate constants for the formation of the two oxime derivatives of Category-2 metabolites, and w₁^{M} & w₂^{M} are the relative response ratios for the two derivatives of each Category-2 Metabolite M. From the equation above it is clear that k_{M}*—which represents the ratio of the RPA of the two derivative forms will remain constant as long as the derivatization conditions are constant (constant k_{O}) and the GC-MS conditions remain constant (constant w₁^{M} and w₁^{M}). Both these conditions are essential assumptions before performing any Metabolomic data analysis.

Hence, in operation 1004, k_{M}* between the two relative peak areas of the known Category-2 metabolites are estimated and used in each of the acquired profiles to validate that the GC-MS operating conditions remain constant throughout the data acquisition process.

In operation 1006, a determination is made if inconsistencies are observed in k_{M}* values. In other words, a determination is made whether all k_{M}* ratios are constant for all profiles. If not, the corresponding metabolomic profiles are excluded from further analysis and flow proceeds, to operation 1001 for additional measurement of inconsistent samples. If however, k_{M}* values are constant for all profiles, flow proceeds to operation 1008.

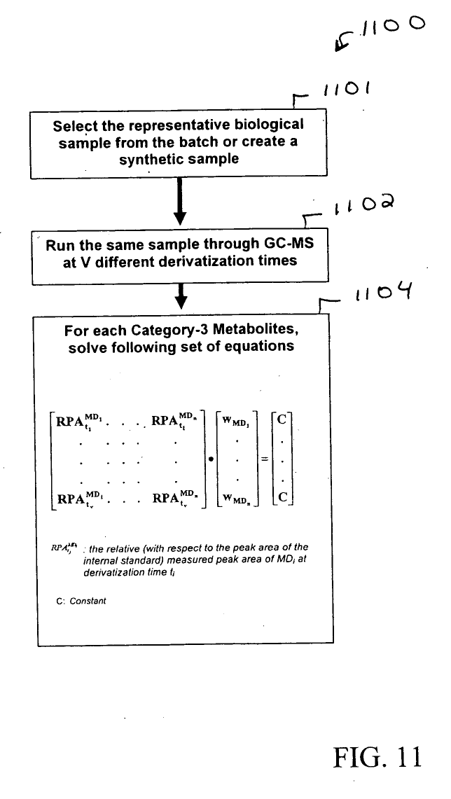

In operation 1008, after having ensured constant GC-MS conditions for all the samples being analyzed (which is the pre-requisite for using wᵢ^{M} values), the values wᵢ^{M} for each Category-3 metabolite at the particular GC-MS operating conditions are estimated. Operation 1008 is described in greater detail with respect to FIG. 11 as set forth below.

In operation 1010, for each Category-3 metabolite, using the RPA of it's each derivative forms recorded in a particular GC-MS run and the estimated wᵢ^{M} values, “cumulative peak area” is calculated for the particular metabolite using EQ. 18. This cumulative peak area is now directly proportional to the original relative concentration of the metabolite, in the biological sample, as discussed earlier. Thus by replacing all individual derivatization forms of Category-3 metabolite with the cumulative peak area, the one-to-one proportionality between the measured profile and the original profile is restored. This operation thus “corrects” the metabolomic profile of any known Category-3 metabolite in any of the samples of the particular batch.

In operation 1012, the final metabolomic profile is assembled consisting of (1) RPAs of Category-1 metabolites (2) the largest RPA for Category-2 metabolites and finally (3) “cumulative” RPAs for Category-3 metabolites obtained in operation 710. Thus, the final corrected metabolomic profile obtained at the end of this operation will now have one only relative peak area for each known metabolite, which is proportional to the original concentration of the metabolite in the sample. All duplicate or multiple peaks for the known metabolites are removed through this operation and the desired one-to-one direct proportionality is restored. Having validated and corrected the metabolomic data through operation 1001 to 1012, in operation 1014, statistical analysis of the metabolomic profiles is performed to obtain the relevant biological conclusions of the analysis.

Operations 1001 to 1012 provide a correction strategy for the known part of the acquired metabolomic profiles prior to any attempts of further analysis. In the case of the unknown part of the metabolomic profile, it is important to determine the “molecular origin” of each peak, so it could be categorized in one of the three categories described above. Only the peak areas of Category-1 metabolites could safely be used in the remainder of the analysis. The peak areas of Category-2 metabolites should be paired—no algorithm for such pairing has yet been reported—and only one of the two in each pair should be used in the rest of the analysis. If both are used, a weight of 2 will be assigned to the concentration of the particular unknown metabolite in the rest of the statistical/clustering analysis, since there are two derivatization forms for Category-2, wherein both of which represent the original metabolite. Peaks of category-3 metabolites are identified from their profile with the derivatization time, as this is the only category whose derivatization forms show a change in their relative peak area, even after time T_{M}. However, unless these peaks are combined into groups representing the same unknown metabolite and “corrected” based on the presented normalization strategy, they should not be used in further statistical analysis. The resulted mathematical artifacts could be significant, and assigning them a biological meaning could lead to erroneous results.

FIG. 11 illustrates a flow chart 1100 corresponding to operation 1008 set forth in FIG. 10. In operation 1101, a biological sample of the examined batch to be used for the estimation of the wᵢ^{M} values of all Category-3 metabolites is selected. This sample should comprise all Category-3 known metabolites. If this is not possible, more than one samples need to be used in this repetitive measurement process. Barring changes in the GC-MS conditions, a synthetic sample resembling the composition of an average biological sample of the examined type could be prepared and used for the estimation of the wᵢ^{M} values of all known Category-3 metabolites. In this case, the concentration of each Category-3 metabolite in the synthetic sample would be known and the estimated wᵢ^{M} values would represent the relative response ratios of the metabolite's M derivatives.

In operation 1102, the selected biological or synthetic sample at V derivatization times longer than T_{M} are run through the GC-MS process. The selection of the longest derivatization time, T_{final}, should satisfy two criteria: (a) the system of EQ. 18, EQ. 19, or EQ. 20 should be over-determined for any of the Category-3 metabolites to enable data reconciliation, and (b) derivative degradation should not have yet occurred. Based upon experimental observations, if T_{M} is 6 hours, degradation is not observed at derivatization times shorter than 30 hours.

As any other high-throughput biomolecular profiling analysis to-date, metabolomic profiling has been mainly used to differentiate between various cellular states and/or identify an environmental or genetic phenotype. When the objective is only the former, profiles are compared as a whole with little interest in peak identity. In this case, each peak has been typically considered independent of the others, including peaks corresponding to derivatives of the same metabolite. When the objective is the latter, peak identity is of interest. Based on the reported results, it seems that, in this case, one of its derivatives (usually the largest) has been typically used to represent the original metabolite. Based on the previous discussion regarding molecular categorization, both practices could lead to erroneous conclusions, since only the Category-1 metabolites are in one-to-one directly proportional relationship with their derivative peak areas. Even for these metabolites, the duration of derivatization is important for quantitative metabolomic profiling analysis. For Category-2 metabolites using both derivatives in further statistical analysis will introduce bias. The practice of using one of the two peak areas (usually the largest) to represent the original metabolite is, in this case, correct, even though it has been primarily based on the fact that one of the two peaks is usually largely inconsistent. However, even for Category-2 metabolites, it is not clear from the published reports whether the selection of one derivative to represent the original metabolite is used before any statistical analysis or at the stage of the presentation of the results. As shown in connection with the molecular categorization and analysis described herein for a Category-3 metabolite, choosing one of multiple derivative peak areas as representative of its concentration in the original sample could introduce error.

To identify the extent of the bias introduced in the statistical analysis when choosing one derivative peak area as representative of an original concentration, and to validate the presented normalization/correction strategy, multiple spectra of pure amino acid, synthetic and two real plant samples were analyzed.

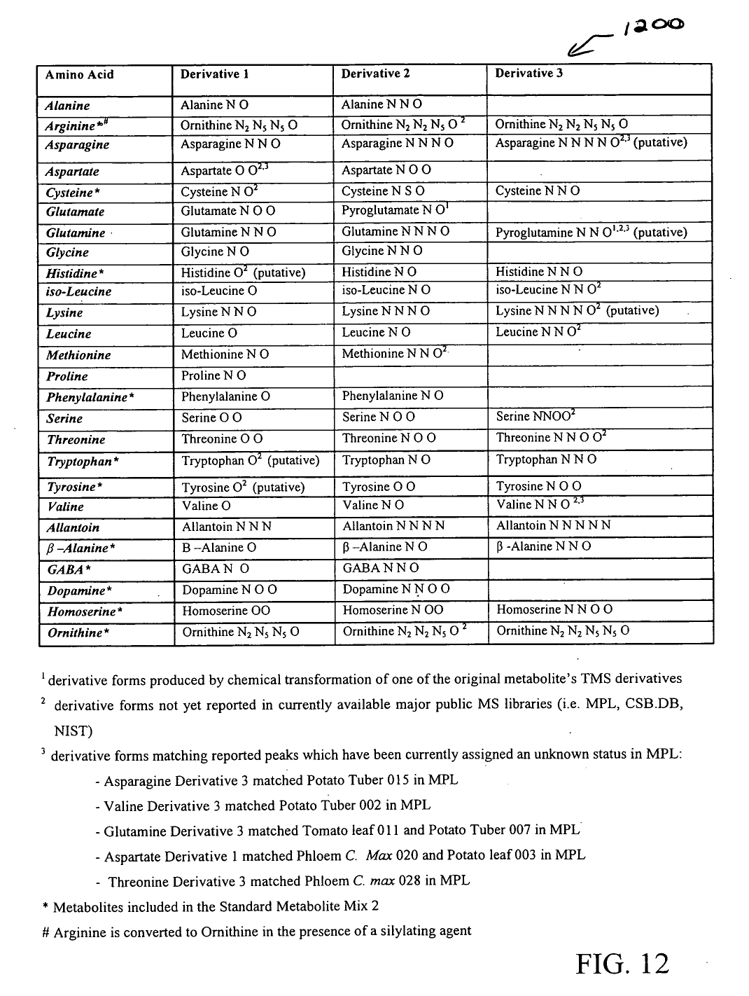

FIG. 12 illustrates a table 1200 of all consistently observed TMS-derivatives of 26 amino acids & amine compounds (Category-3 metabolites) in the mass spectra of plant sample 1, a metabolite mix and amino acid standards. All samples underwent the repetitive measurement process described above for a derivatization period of 25 hours. The derivatives are shown in the order they were produced.

In table 1200, superscript 1 denotes derivative forms produced from chemical transformation of one of the original metabolite's TMS derivative and superscript 2 denotes derivative forms not yet reported in any of the currently available major public MS libraries (MPL, NIST). Superscript 3 denotes derivative forms matching reported peaks which have currently been assigned an unknown status in MPL: Asparagine Derivative 3 matched Potato Tuber 015 in MPL; Glutamine Derivative 3 matched Tomato leaf 011 and Potato Tuber 007 in MPL; Aspartate N O matched Phloem C. Max 020 and Potato leaf 003 in MPL; Valine N N O matched Potato Tuber 02 and Threonine Derivative 3 matched Phloem C. max 028 in MPL. Metabolites marked with (*) were part of Standard Metabolite Mix 2.

Plant sample 1, metabolite mix and pure amino acid standards underwent the repetitive measurement process for the estimation of the wᵢ^{M} values of all amino acids observed in the plant samples. Table 1200 comprises the TMS-derivatives of all 26 amino acids that were consistently observed in the measured derivatization period (25 hours).

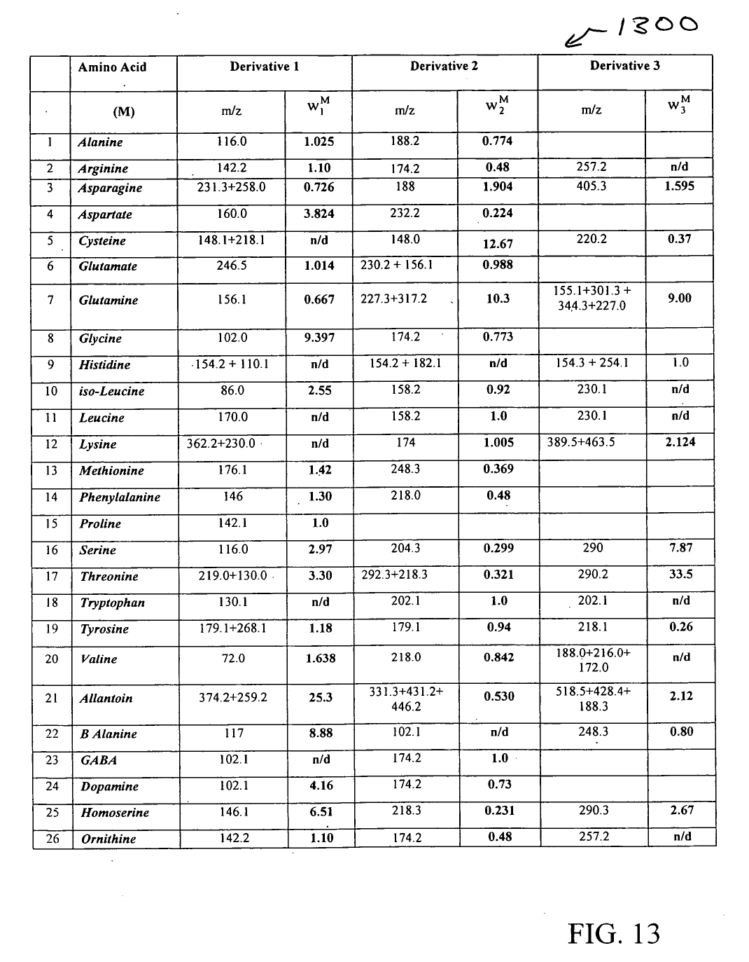

FIG. 13 illustrates a table 1300 of estimated wᵢ^{M} values of all amino acids shown in table 1200 of FIG. 12. Table 1300 is provided for a particular set of GC-MS operating conditions and the indicated marker ion(s) (mass-to-charge ratio m/z). Plant sample 1 was used for the estimation of wᵢ^{M}'s of Category-3 metabolites 3, 6-7, 16-17 and 25. Standard Metabolite Mix-1 was used for estimation of wᵢ^{M}'s of metabolite 1, 8, 10, 12-13 and 20. Standard Metabolite Mix-2 was used for estimation of wᵢ^{M}'s of metabolite 2, 5, 14, 18-19, 22, 24 and 26. Standard Metabolite runs was used for estimation of wᵢ^{M}'s of metabolite 4 and 21.

The estimated wᵢ^{M} values varied in a range of two orders of magnitude, from ˜0.1 to ˜10. Of note, the largest wᵢ^{M} values did not always correspond to the largest derivative peak areas of a particular metabolite. This indicates that (a) even a small Category-3 derivative peak area could significantly contribute to the cumulative peak area and thereby should not be ignored, as it seems to be the current practice, and (b) significant bias might be introduced in the analysis, if only one (often the largest) derivative peak area is selected to represent the metabolite of interest.

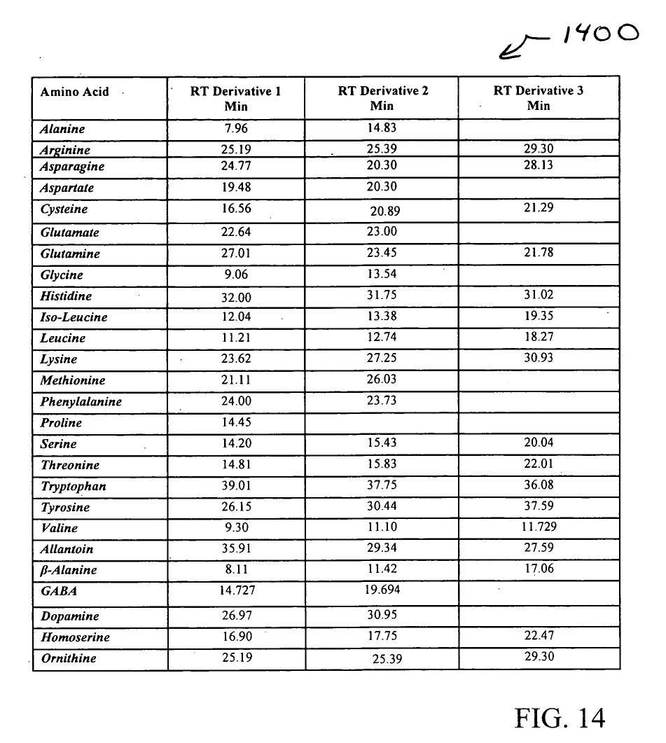

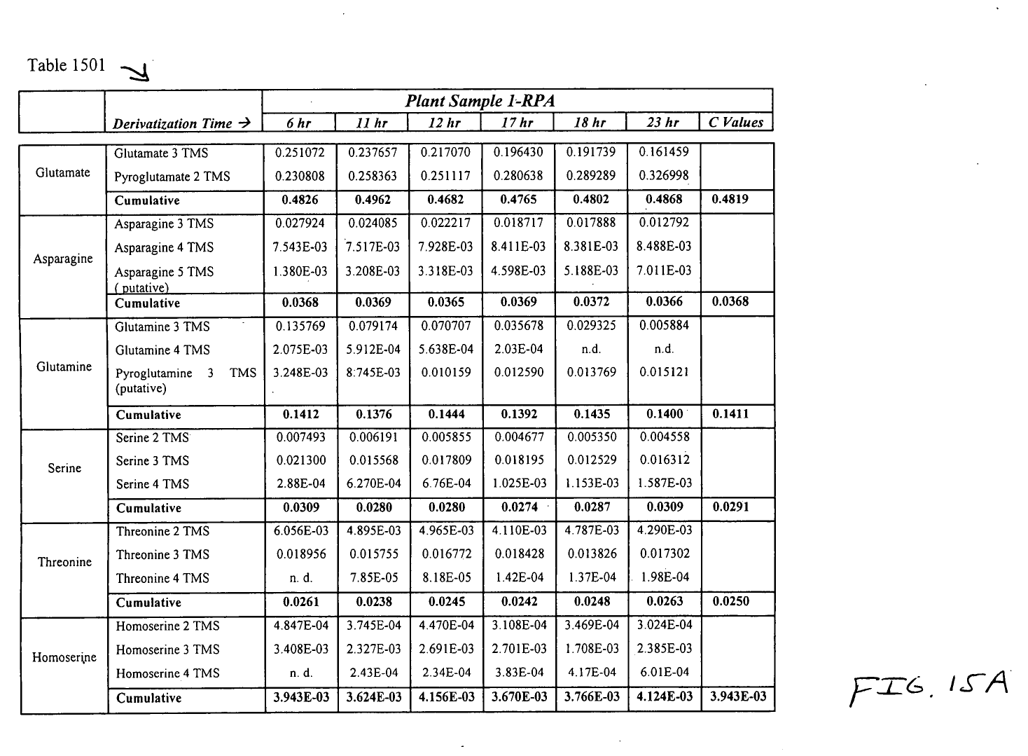

FIG. 14 illustrates a table 1400 showing observed retention times for Category-3 metabolites shown in table 1200 of FIG. 12. Table 1400 is provided for a particular set of GC-MS operating conditions. Plant samples, Metabolite Standards, and Standard Metabolite Mix were used for obtaining the retention time.

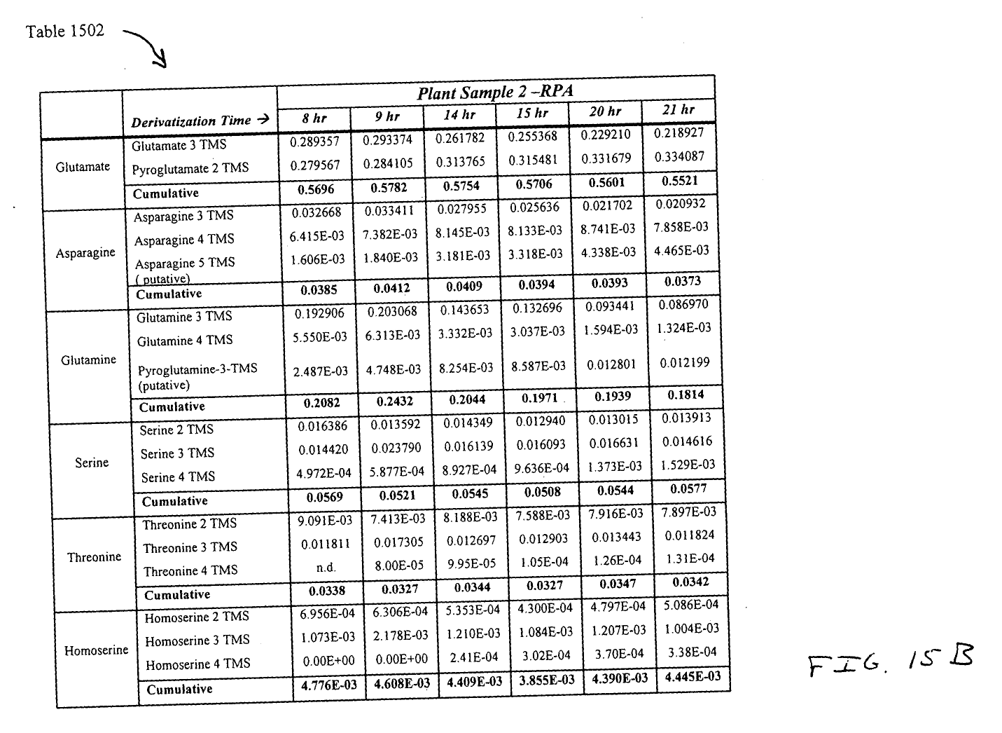

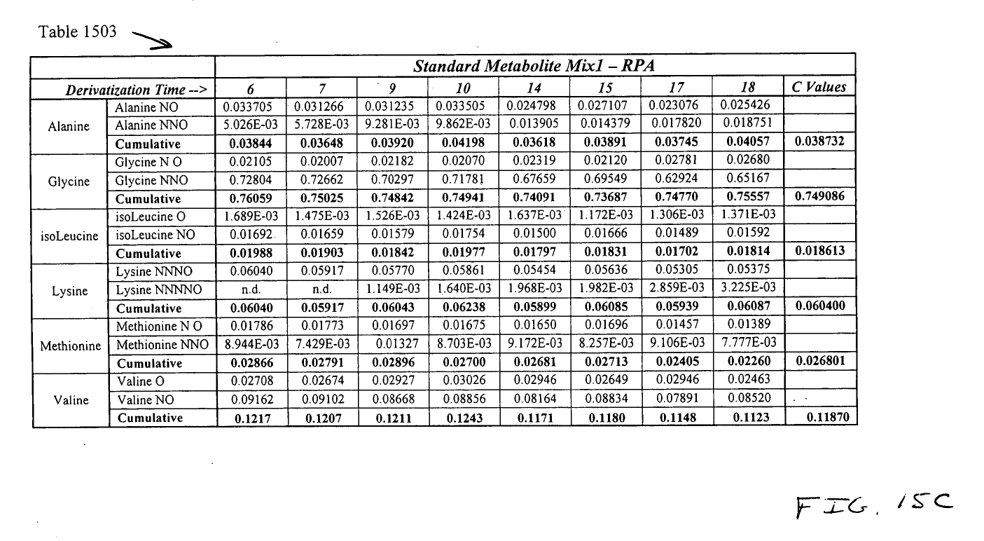

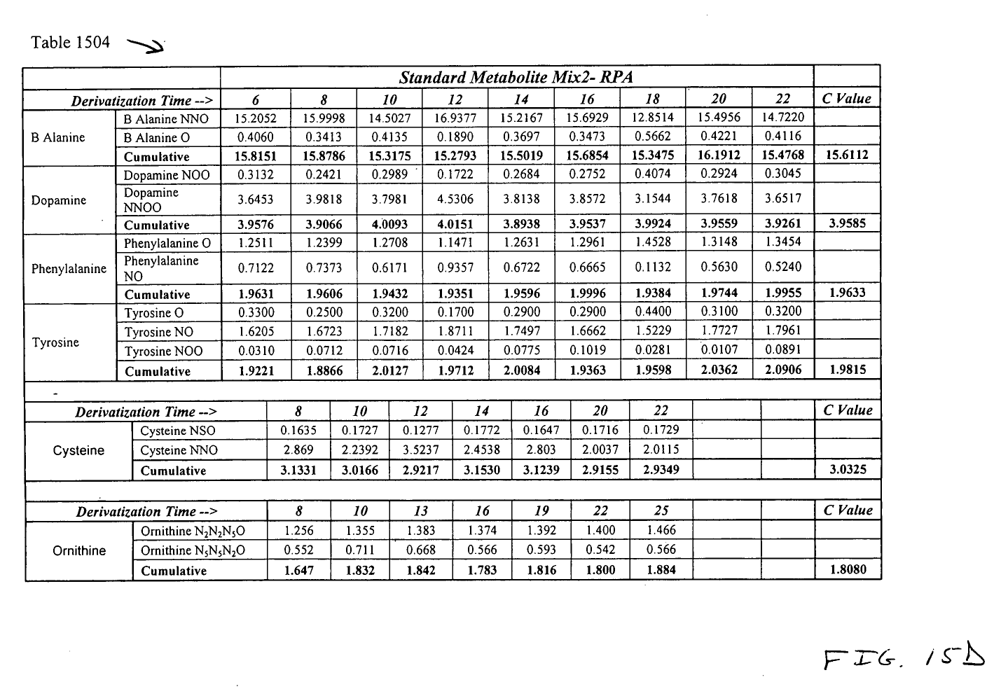

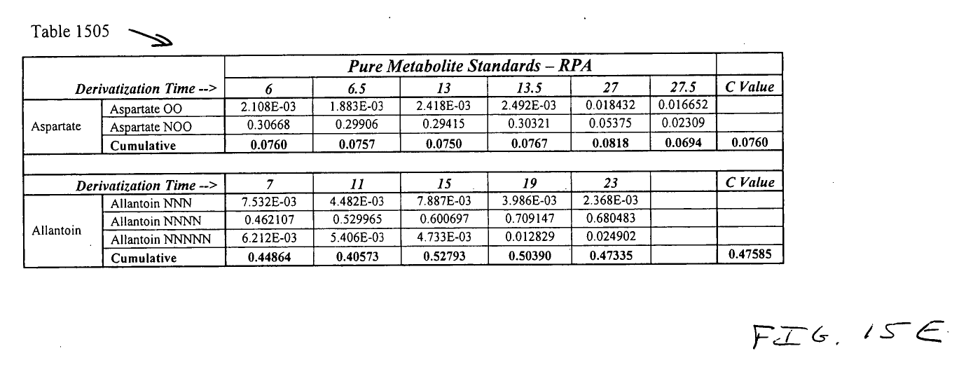

FIGS. 15A-15E illustrate tables containing relative peak area values and constant C which were used for estimating the wᵢ^{M} values in table 1300 of FIG. 13. Table 1501 shows relative peak areas and constant C which were used for estimation of wᵢ^{M}'s for Category-3 metabolites 3, 6-7, 16-17 and 25 in table 1300 of FIG. 13. Table 1503 shows relative peak areas and constant C which were used for estimation of wᵢ^{M}'s for Category-3 metabolites 1, 8, 10, 12-13 and 20 in table 1300 of FIG. 13. Table 1504 shows relative peak areas and constant C which were used for estimation of wᵢ^{M}'s for Category-3 metabolites 2, 5, 14, 18-19, 22, 24 and 26 in table 1300 of FIG. 13. Table 1505 shows relative peak areas and constant C which were used for estimation of wᵢ^{M}'s for Category-3 metabolites 4 and 21 in table 1300 of FIG. 13.

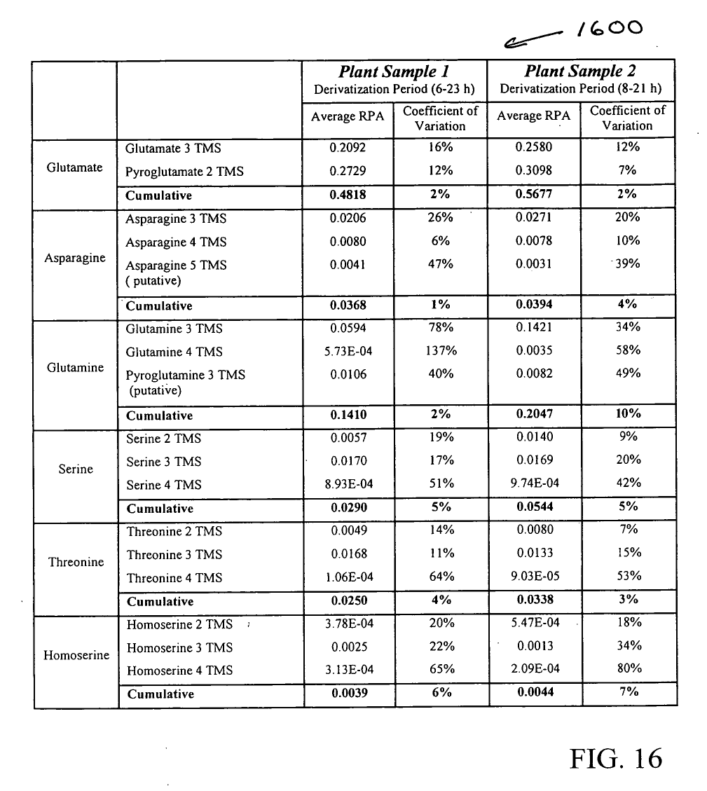

FIG. 16 illustrates table 1600 showing observed average relative cumulative peak areas in plant sample 1 and plant sample 2 metabolites containing amine group. The observed relative cumulative peak areas are provided with respect to an internal standard. The derivative and estimated cumulative peak areas of all observed plant sample 1 and plant sample 2 amino acids have multiple derivatization forms, averaged among mass spectra acquired throughout the depicted derivatization period. The average relative peak areas and co-variance of derivatives for plant sample 1 were calculated from table 1501 of FIG. 15. The average relative peak areas and co-variance of derivatives for plant sample 2 were calculated from table 1502 of FIG. 15. The wᵢ^{M} values shown in table 1300 of FIG. 13 were used. The very small coefficient of variation in the cumulative amino acid peak areas validates the accuracy of the described correction methodology. In addition, it is now possible to quantify the change in the amino acid concentration between the two biological states, which was not the case in the absence of a cumulative peak area value. As set forth in greater detail above, the value RPA represents the relative peak area of a particular derivative with respect to the internal standard.

In addition, as per the present practice, when individual derivatization forms of amino acids were considered, the average variation of 38% and 30% was observed in the derivative peak areas of all the metabolites containing amine compounds in the plant samples, throughout all the spectra that were measured at derivatization times larger than T_{M}. However, when these individual derivatization forms were combined as “cumulative” peak areas, the variation with derivatization time was reduced to 3% and 5%, respectively, after the application of the proposed normalization strategy.

The above is a significant result, because it validates the proposed methodology. The cumulative peak area of all amino acids representing their concentration in the original sample is not supposed to change among the measured spectra. Moreover, the above result indicates the extent of the bias that could be introduced in the statistical analysis if the amino acid and any other Category-3 metabolite peaks are used as independent. Variation due only to the molecular characteristics of these metabolites and the GC-MS analysis principles could be erroneously attributed biological significance. Finally, the above result shows that, after the estimation of an effective peak area, it is now possible to accurately quantify the change in Category-3 metabolite's concentration among various biological samples. This was not the case when individual derivative peak areas of Category-3 metabolites were compared.

One result of the mass spectral analysis for the validation of the proposed correction strategy was the identification of fifteen (15) derivatives of metabolites containing amine group, which either had not been reported before in public databases (NIST, MPL,CSB.DG), or matched reported peaks which have currently been assigned an unknown status in MPL (See table 1200 of FIG. 12). This identification was made possible through the analysis of spectra of pure amino acid samples. One of the currently reported unknown peaks was identified as a chemical transformation derivative of glutamine-4-TMS. Moreover, pyroglutamate-2-TMS was validated to be a chemical transformation derivative of glutamate-3-TMS, as reported in the technical literature. Many recent studies as reported in the technical literature, however, have treated the above transformation as independent of glutamate. These discoveries are important, considering that (a) much effort in metabolomics is invested in the annotation of unknown peaks, (b) current statistical analyses may be biased due to dependency between peaks, currently considered as independent, (c) variation in effective peak areas of known compounds with derivatization time, barring change in operating conditions, implies the presence of additional, still unidentified, derivative(s), and (d) variation in unknown peak areas with derivatization time might provide clues for the chemical formula (e.g. (—NH₂)-groups) of the corresponding metabolite.

Finally, even though the data normalization strategy was demonstrated in the context of TMS-derivatives, it could be accordingly applied to any other derivatization type in metabolomic or any other high-throughput chemical analysis application. For example, in the case of tert-butyl-dimethylsilyl(“TBDMS”)-derivatives, the issue of sequential derivatization reactions affects not only compounds with (—NH₂)-groups, but also sugars and sugar-alcohols (see metabolomics public library (“MPL”) above).

The following operations and standards were used in the above examples:

Category-3 metabolite standards: Vacuum-dried 200 μL equal-volume mixture of 1 mg/mL amino acid solution in 1:1 (v/v) methanol and water and 1 mg/mL ribitol (as internal standard) solution in water; for cysteine, arginine, histidine and tryptophan, ˜1 mg pure standard samples were derivatized directly, without prior treatment with methanol-water solution and subsequent drying, were also prepared;

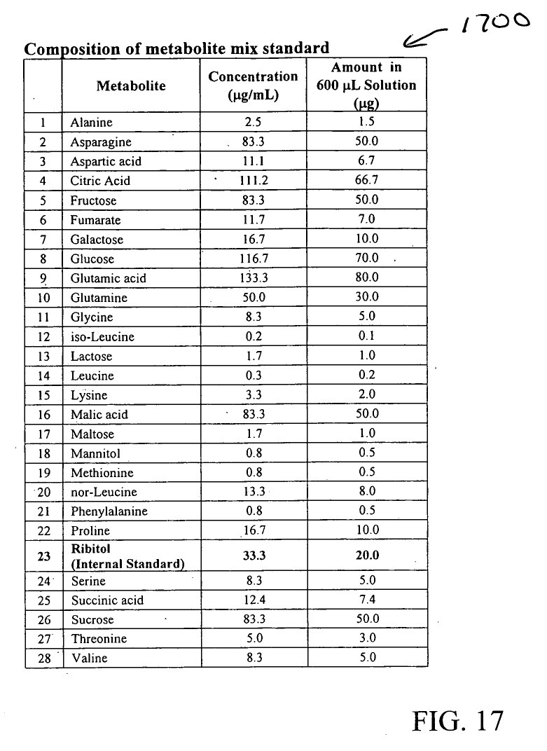

Standard Metabolite Mix 1: Vacuum-dried 600 μL solution of 27 metabolites (16 amino acids, 4 organic acids, 7 sugar/sugar alcohols) and ribitol (as internal standard) in 1:1 (v/v) methanol and water (see table 1700 of FIG. 17);

Standard Metabolite Mix 2: A mixture of ˜1 mg from each of the 10 category-3 metabolites flagged with asterisk(*) in Table 1200 of FIG. 12;

Plant Samples: Vacuum-dried polar extracts using a scientifically accepted extraction protocol from ˜125 mg of ground A. thaliana liquid cultures. The cultures were grown in 200 mL of “Gamborg” media with 20 g/L sucrose under constant light (80-100 μmole/m².s) and temperature (23° C.) in the controlled environment of an EGC M-40 growth chamber. Two cultures were used in present analysis; plant sample 1 was 12 days and 9 hour old, while plant sample 2 was 13 days and 6 hours old. All reagents were procured from Sigma, known source;

GC-MS runs: Multiple replicates of the plant, standard metabolite mix and amino acid samples were derivatized according to a scientifically accepted method and run at various derivatization times, in two consecutive injections (run duration: 56 minutes), at 1:35 split ratio, using Varian 2100 GC-(ion-trap) MS fitted with 8400 auto-sampler. In the case of the plant and metabolite mix 1 samples, 100 μL of 20 mg/mL Methoxyamine HCL solution in pyridine was added to each sample and allowed to react for 30 mins followed by the addition of 100 μL MSTFA. In the case of pure metabolite samples, 30 instead of 100 μL MSTFA were used, balanced out by 70 μL of pyridine. In the case of the cysteine, arginine, histidine, tryptophan and metabolite mix 2 samples that were prepared without the addition of methanol-water solution and the subsequent drying, 100 μL of 2 μg/μL ribitol solution in pyridine and 300 μL of pyridine were initially added to each sample. Subsequently, the sample reacted for 30 mins with 100 μL of 20 mg/mL Methoxyamine HCL solution in pyridine followed by the addition of 500 μL MSTFA. GC-MS operating conditions followed a scientifically accepted protocol. All reagents were procured from Sigma, a known source; and

Data acquisition and analysis: Metabolite peak identification was based on (a) own library of standards, (b) publicly available TMS-derivative library (MPL) and the Public Repository for Metabolomic Mass Spectra—CSB.DB GOLM Metabolome database available on the internet (referred to as CSB.DB), and (c) the commercially available NIST MS-library.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

We claim:

1. A method of profiling wherein a sample is combined with a derivatizing agent to produce derivatives and a separation-molecular ID and quantification process is performed on the derivatives to obtain corresponding peak areas, comprising:
measuring the peak areas of the derivatives; and
adding the measured peak areas as weighted sums.

2. The method of claim 1 wherein the measured peak areas are relative peak areas with respect to an internal standard.

3. The method of claim 2 wherein the relative peak areas are transformed into the weighted sums through multiplication with respectively corresponding relative response ratios.

4. The method of claim 1, further comprising:
quantifying original components present within the sample corresponding to the measured peak areas.

5. The method of claim 1, further comprising:
identifying original components present within the sample corresponding to the measured peak areas.

6. The method of claim 1, further comprising:
quantifying original components present within the sample corresponding to the weighted sums.

7. The method of claim 1, further comprising:
identifying original components present within the sample corresponding to the weighted sums.

8. The method of claim 1 wherein the sample is a metabolite and the derivatives are metabolite derivatives.

9. The method of claim 1 wherein the sample is a protein and the derivatives are protein derivatives.

10. The method of claim 1 wherein the sample is a lipid and the derivatives are lipid derivatives.

11. The method of claim 1 wherein the separation-molecular ID and quantification process is gas chromatography-mass spectrometry.

12. The method of claim 1 wherein the separation-molecular ID and quantification process is liquid chromatography-mass spectrometry.

13. The method of claim 1 wherein the separation-molecular ID and quantification process is capillary electrophoresis-mass spectrometry.

14. The method of claim 1 wherein at least two of the derivatives have corresponding peak areas that form a corresponding mathematical ratio, further comprising:
repeatedly measuring the peak areas of said at least two derivatives and repeatedly calculating the corresponding mathematical ratios from the repeatedly measured peak areas.

15. The method of claim 14, further comprising:
calculating a change in the mathematical ratios, wherein the calculated change provides an indicia of quality in the separation-molecular ID and quantification process.

16. The method of claim 14 wherein the mathematical ratio corresponds to a ratio of concentrations of said at least two derivatives.

17. A method of metabolomic profiling comprising:
combining a first metabolite having an initial concentration with a derivatizing agent to produce a plurality of metabolite derivatives with different respective concentrations;
conducting a separation-molecular ID and quantification process on the metabolite derivatives to obtain corresponding quantifiable molecular ID spectra;
measuring relative peak areas for each of the metabolite derivatives from the molecular ID spectra; and
adding the measured relative peak areas as weighted sums.

18. The method of claim 17, further comprising:
quantifying the first metabolite concentration from the weighted sums.

19. The method of claim 17, further comprising:
identifying the first metabolite from the weighted sums.

20. The method of claim 17, wherein the plural metabolite derivatives are created sequentially upon reaction with the derivatizing agent, and said measuring act is performed after the first metabolite has substantially reacted with the derivatizing agent.

21. The method of claim 17, further comprising:
determining a time t_{M} wherein the first metabolite has substantially reacted with the derivatizing agent; and
measuring the relative peak areas for each of the metabolite derivatives after the time t_{M}.

22. The method of claim 21, wherein the relative peak areas are measured before the metabolite derivatives have established steady state equilibrium.

23. The method of claim 21, wherein the relative peak areas are measured before the metabolite derivatives have substantially degraded.

24. The method of claim 17, wherein the plural metabolite derivatives are created sequentially upon reaction with the derivatizing agent, further comprising:
repeatedly measuring relative peak areas for each of the metabolite derivatives from the molecular ID spectra; and
determining plural proportionality ratios corresponding to the repeatedly measured relative peak areas for each of the metabolite derivatives.

25. The method of claim 17, further comprising:
determining a cumulative relative peak area corresponding to the initial concentration of the first metabolite.

26. The method of claim 17, further comprising:
combining a second metabolite with a second derivatizing agent to produce a plurality of second metabolite derivatives with different respective concentrations;
conducting a separation-molecular ID process on the second metabolite derivatives to obtain corresponding second molecular ID spectra; and
measuring relative peak areas for each of the second metabolite derivatives from the molecular ID spectra; and
adding the measured relative peak areas of the second metabolite derivatives as weighted sums.

27. The method of claim 26, further comprising:
quantifying the second metabolite concentration from the weighted sums.

28. The method of claim 26 wherein at least two of the second metabolite derivatives have corresponding peak areas that form a corresponding mathematical ratio, further comprising:
repeatedly measuring the peak areas of said at least two second metabolite derivatives and repeatedly calculating the corresponding mathematical ratios from the repeatedly measured peak areas.

29. The method of claim 28, further comprising:
calculating a change in the mathematical ratios, wherein the calculated change provides an indicia of quality in the separation-molecular ID and quantification process.

30. A method of metabolomic profiling comprising:
combining a sample metabolite with a derivatizing agent to produce a plurality of metabolite derivatives with different concentrations changing as a function of time;
conducting a separation-molecular ID process on the metabolite derivatives at a plurality of times greater than t_{M} when the original metabolite has substantially reacted with the derivatizing agent; and
determining relative response ratios between the plural metabolite derivatives and the sample metabolite.

31. The method of claim 30 wherein at least two of the metabolite derivatives have corresponding peak areas that form a corresponding mathematical ratio, further comprising:
repeatedly measuring the peak areas of said at least two metabolite derivatives and repeatedly calculating the corresponding mathematical ratios from the repeatedly measured peak areas.

32. The method of claim 31, further comprising:
calculating a change in the mathematical ratios, wherein the calculated change provides an indicia of quality in the separation-molecular ID and quantification process.

33. A method of metabolomic profiling comprising:
combining a first metabolite with a derivatizing agent to produce a plurality of metabolite derivatives with different respective concentrations;
conducting a separation-molecular ID process on the metabolite derivatives at a plurality of times; and
determining relative response ratios between the plural metabolite derivatives and the first metabolite using the following formula:
$$[ \begin{matrix}{RPA}_{{t}_{1}}^{{MD}_{1}} & ⋯ & {RPA}_{{t}_{1}}^{{MD}_{n}} \\ . & ⋯ & . \\ . & ⋯ & . \\ . & ⋯ & . \\ {RPA}_{{t}_{v}}^{{MD}_{1}} & ⋯ & {RPA}_{{t}_{v}}^{{MD}_{n}}\end{matrix} ] . [ \begin{matrix}{w}_{1}^{M} \\ . \\ . \\ . \\ {w}_{n}^{M}\end{matrix} ] = [ \begin{matrix}\frac{[ {M}_{o} ]}{[ {Co}_{IS} ]} \\ . \\ . \\ . \\ \frac{[ {M}_{o} ]}{[ {Co}_{IS} ]}\end{matrix} ]$$
where n is the number of the first metabolite derivatives, MDᵢ is the i-th derivative of the first metabolite, RPAₜ_{ⱼ}^{MD}^{ᵢ} is the relative measured peak area corresponding to the i-th derivative of metabolite M at the derivatization time tⱼ at which the j^{th} sample comprising metabolite M at concentration [Mⱼ] has been measured, Co_{IS} is a known concentration of added internal standard (“IS”) in the first metabolite, and wᵢ^{M} is the relative response ratio with respect to the internal standard.

34. A method of metabolomic profiling comprising:
combining a first metabolite with a derivatizing agent to produce a plurality of metabolite derivatives with different respective concentrations;
conducting a separation-molecular ID process on the metabolite derivatives at a plurality of times; and
determining relative response ratios between the plural metabolite derivatives and the first metabolite using the following formula:
$$[ \begin{matrix}{RPA}_{{t}_{1}}^{{MD}_{1}} & ⋯ & {RPA}_{{t}_{1}}^{{MD}_{n}} \\ . & ⋯ & . \\ . & ⋯ & . \\ . & ⋯ & . \\ {RPA}_{{t}_{v}}^{{MD}_{1}} & ⋯ & {RPA}_{{t}_{v}}^{{MD}_{n}}\end{matrix} ] . [ \begin{matrix}{w}_{1}^{M} \\ . \\ . \\ . \\ {w}_{n}^{M}\end{matrix} ] = [ \begin{matrix}\frac{[ {M}_{1} ]}{[ {Co}_{IS} ]} \\ . \\ . \\ . \\ \frac{[ {M}_{v} ]}{[ {Co}_{IS} ]}\end{matrix} ]$$
where n is the number of the first metabolite derivatives, MDᵢ is the i-th derivative of the first metabolite, RPAₜ_{ⱼ}^{MD}^{ᵢ} is the relative measured peak area corresponding to the i-th derivative of metabolite M at the derivatization time tⱼ at which the j^{th} sample comprising metabolite M at concentration [Mⱼ] has been measured, Co_{IS} is a known concentration of added internal standard (“IS”) in the first metabolite, and wᵢ^{M} is the relative response ratio with respect to the internal standard.

35. A method of metabolomic profiling comprising:
combining a first metabolite with a derivatizing agent to produce a plurality of metabolite derivatives with different respective concentrations;
conducting a separation-molecular ID process on the metabolite derivatives at a plurality of times; and
determining relative response ratios between the plural metabolite derivatives and the first metabolite using the following formula:
$$[ \begin{matrix}{RPA}_{{t}_{1}}^{{MD}_{1}} & ⋯ & {RPA}_{{t}_{1}}^{{MD}_{n}} \\ . & ⋯ & . \\ . & ⋯ & . \\ . & ⋯ & . \\ {RPA}_{{t}_{v}}^{{MD}_{1}} & ⋯ & {RPA}_{{t}_{v}}^{{MD}_{n}}\end{matrix} ] . [ \begin{matrix}{w}_{{MD}_{1}} \\ . \\ . \\ . \\ {w}_{{MD}_{2}}\end{matrix} ] = [ \begin{matrix}C \\ . \\ . \\ . \\ C\end{matrix} ]$$
where n is the number of the first metabolite derivatives, RPAₜ_{ⱼ}^{MD}_{ᵢ} is the relative measured peak area corresponding to the i-th derivative of metabolite M at the derivatization time tⱼ at which the j^{th} sample comprising metabolite M at concentration [Mⱼ] has been measured, and C is a constant.

36. A method of metabolomic profiling comprising:
combining a first metabolite and a second metabolite with a derivatizing agent to produce a first metabolite derivative and plural sequentially derived second metabolite derivatives;
determining a minimum derivatization time for conversion of each of the first and second metabolites into the first or plural second respectively corresponding derivatives;
identifying peak areas from a separation-molecular ID process for the first metabolite derivative and each of the plural second derivatives at a particular time greater than the minimum derivatization time; and
estimating relative response ratios that correspond the relative concentrations of the second derivatives with the identified second peak areas.

37. The method according to claim 36, further comprising:
estimating a cumulative peak area from the estimated relative response ratios.

38. The method of claim 36 wherein at least two of the derivatives have corresponding peak areas that form a corresponding mathematical ratio, further comprising:
repeatedly measuring the peak areas of said at least two derivatives and repeatedly calculating the corresponding mathematical ratios from the repeatedly measured peak areas; and
calculating a change in the mathematical ratios, wherein the calculated change provides an indicia of quality in the separation-molecular ID and quantification process.

39. A method of metabolomic profiling comprising:
combining a first metabolite having an initial concentration with a derivatizing agent to produce a plurality of metabolite derivatives with different respective concentrations;
conducting a separation-molecular quantification process on the metabolite derivatives to obtain corresponding quantifiable molecular ID spectra;
measuring relative peak areas for each of the metabolite derivatives from the molecular ID spectra; and
quantifying the first metabolite concentration by adding the measured relative peak areas as weighted sums.

40. A method of metabolomic profiling comprising:
combining a metabolite with a derivatizing agent to produce at least two metabolite derivatives having corresponding peak areas that form a corresponding mathematical ratio;
repeatedly conducting a separation-molecular ID process on the metabolite derivatives; and
repeatedly measuring the peak areas of said at least two metabolite derivatives and repeatedly calculating the corresponding mathematical ratios from the repeatedly measured peak areas.

41. The method of claim 40, further comprising:
calculating a change in the mathematical ratios, wherein the calculated change provides an indicia of quality in the separation-molecular ID and quantification process.
